(19) United States
(12) Patent Application Publication
(10) Pub. No.: US 2023/0075692 A1
(43) Pub. Date: Mar. 9, 2023

(54) SYSTEMS AND METHODS FOR PROVIDING TOUCHLESS FOOD SERVICE

(71) Applicant: The Vollrath Company, L.L.C., Sheboygan, WI (US)

(72) Inventors: Jill Hundley, Sheboygan, WI (US); Chuck Smiley, Sheboygan, WI (US); Christopher Niemann, Howards Grove, WI (US); Ken Wetenkamp, Plymouth, WI (US); Mike Komendat, Sheboygan, WI (US); Matt Gagner, Sheboygan, WI (US)

(73) Assignee: The Vollrath Company, L.L.C., Sheboygan, WI (US)

(21) Appl. No.: 17/940,390

(22) Filed: Sep. 8, 2022

Related U.S. Application Data
(60) Provisional application No. 63/242,371, filed on Sep. 9, 2021.
(60) Provisional application No. 63/342,281, filed on May 16, 2022.

(51) Int. Cl. A47F 10/06; A47F 3/04

(52) U.S. Cl. CPC A47F 10/06; A47F 3/0408; G06Q 50/12

(57) ABSTRACT

A food service system comprising a housing having a first bay, a first positioning bracket having a first opening, and a first power supply module having a first mounting interface. The system may further comprise a first canister to selectively couple the first power supply module and controllably dispense a first food product, where the first canister comprises a first receptacle, a first base coupled to the first receptacle, and a first dispenser. The system may further comprise a first drive motor module removably mounted to the first base and operatively coupled to the first dispenser, where the first canister is removably mounted in the first bay by at least an engagement between the first drive motor module and the first mounting interface, and where the first drive motor module may actuate the first dispenser and the first dispenser controllably dispenses the first food product.

### CROSS-REFERENCE TO RELATED PATENT APPLICATIONS

This patent application claims benefit of and priority to U.S. Provisional Patent Application No. 63/242,371, filed on Sep. 9, 2021, and U.S. Provisional Patent Application No. 63/342,281, filed on May 16, 2022, which are both hereby incorporated by reference in their entirety.

### BACKGROUND

The present disclosure relates generally to a food service system. More specifically, the present disclosure relates to an automated and/or touchless food service system.

Conventional self-service salad bars or other buffets typically store food in open-top trays that are cooled from underneath the trays. Breath guards (clear shields, etc.) can be included to partially protect the food and trays from contamination. Consumers must reach between the food breath guards and the trays to access the food and manually move their desired food item to a bowl (or plate, etc.). Such actions may not be ergonomically-friendly given the geometry of the breath guards and trays, and may result in cross-contamination of different foods in different trays (e.g., due to consumer errors in attempting to move food to their bowls). The proximity of consumers' hands to the food may also be undesirable. Accordingly, a food service system which addresses such challenges of conventional self-service salad bars would be desirable.

### SUMMARY

At least one embodiment relates to a food service system for controllably dispensing a first food product, the food service system comprising a housing having a first bay defined by one or more walls, a first positioning bracket mounted in the first bay and having a first opening, and a first power supply module having a first mounting interface. The food service system may further comprise a first canister configured to selectively couple with the first power supply module and controllably dispense the first food product using power from the first power supply module. The first canister may comprise a first receptacle, a first base coupled to the first receptacle, and a first dispenser, where the first base may have a first outlet aligned with the first opening in the first positioning bracket. The food service system may further comprise a first drive motor module removably mounted to the first base and operatively coupled to the first dispenser. Further, the first canister may be removably mounted in the first bay by at least an engagement between the first drive motor module and the first mounting interface of the first power supply module, and the first drive motor module may actuate the first dispenser in response to an electrical signal and the first dispenser controllably dispenses the first food product from the first receptacle to the first outlet.

Another embodiment relates to a food dispensing apparatus, comprising a receptacle configured to selectively house a food product and a base coupled to the receptacle, the base comprising an outlet configured to align with an opening. The food dispensing apparatus may further include a dispenser configured to controllably dispense the food product, and a drive motor module operably coupled to the dispenser, where the drive motor module is configured to use power from a power supply module to cause the dispenser to controllably dispense the food product from the food dispensing apparatus.

Another embodiment relates to a method of providing a food service, the method comprising obtaining food request input data including a first set of sensor data from a first sensor positioned below a first opening of a first canister, and determining properties of a food request based on the food request input data. The method may further include controlling the first canister based on the determined properties of the food request to provide a first food product of the food request, where the first set of sensor data is a first set of proximity sensor data indicating that a dishware is positioned below the first opening. Further, controlling the first canister may include using power from a first power supply module to cause a first drive motor module to actuate a first dispenser, and actuating the first dispenser may include selectively rotating a first spindle coupled to a first plurality of paddles in a first direction to controllably dispense the first food product from the first canister.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a front view of a touchless food service system, according to an exemplary embodiment.

FIG. 2 is a front view of a touchless food service system of FIG. 1, according to an exemplary embodiment.

FIG. 3 is a front view of a touchless food service system of FIG. 1, according to an exemplary embodiment.

FIG. 4 is a front view of a touchless food service system of FIG. 1, according to an exemplary embodiment.

FIG. 5 is a front view of a touchless food service system of FIG. 1, according to an exemplary embodiment.

FIG. 6 is a front view of a module of a touchless food service system of FIG. 1, according to an exemplary embodiment.

FIG. 7 is a front view of a module of a touchless food service system of FIG. 1, according to an exemplary embodiment.

FIG. 8 is a front view of a module of a touchless food service system of FIG. 1, according to an exemplary embodiment.

FIG. 9 is a front view of a of a canister positioning bracket of a touchless food service system of FIG. 1, according to an exemplary embodiment.

FIG. 10 is a front view of a power supply module of a touchless food service system of FIG. 1, according to an exemplary embodiment.

FIG. 11 is a front view of a canister of a touchless food service system of FIG. 1, according to an exemplary embodiment.

FIG. 12 is an exploded view of a canister of a touchless food service system of FIG. 1, according to an exemplary embodiment.

FIG. 13 is a rear view of a base of a canister of a touchless food service system of FIG. 1, according to an exemplary embodiment.

FIG. 14 is a side view of a drive motor module of canister of a touchless food service system of FIG. 1, according to an exemplary embodiment.

FIG. 15 is a front view of a drive motor module of a canister of a touchless food service system of FIG. 1, according to an exemplary embodiment.

FIG. 16 is a front view of another drive motor module of a canister of a touchless food service system of FIG. 1, according to an exemplary embodiment.

FIG. 17 is side view of a disassembled canister of a touchless food service system of FIG. 1, according to an exemplary embodiment.

FIG. 18 is a side view of a canister of a touchless food service system of FIG. 1, according to an exemplary embodiment.

FIG. 19 is a side view of a canister of a touchless food service system of FIG. 1, according to an exemplary embodiment.

FIG. 20 is a front view of a canister of a touchless food service system of FIG. 1, according to an exemplary embodiment.

FIG. 21 is a rear view of a canister of a touchless food service system of FIG. 1, according to an exemplary embodiment.

FIG. 22 is a rear view of another canister of a touchless food service system of FIG. 1, according to an exemplary embodiment.

FIG. 23 is a rear-side view of a canister of a touchless food service system of FIG. 1, according to an exemplary embodiment.

FIG. 24 is a front-side view of a canister of a touchless food service system of FIG. 1, according to an exemplary embodiment.

FIG. 25 is a side view of a canister of a touchless food service system of FIG. 1, according to an exemplary embodiment.

FIG. 26 is a rear view of a canister of a touchless food service system of FIG. 1, according to an exemplary embodiment.

FIG. 27 is a top view of a canister of a touchless food service system of FIG. 1, according to an exemplary embodiment.

FIG. 28 is a front-side view of a canister having an agitation object of a touchless food service system of FIG. 1, according to an exemplary embodiment.

FIG. 29 is a front-side view of another canister having an agitation object of a touchless food service system of FIG. 1, according to an exemplary embodiment.

FIG. 30 is a front view of an agitation object of a touchless food service system of FIG. 1, according to an exemplary embodiment.

FIG. 31 is a front view of another agitation object of a touchless food service system of FIG. 1, according to an exemplary embodiment.

FIG. 32 is a front view of another agitation object of a touchless food service system of FIG. 1, according to an exemplary embodiment.

FIG. 33 is a front view of another agitation object of a touchless food service system of FIG. 1, according to an exemplary embodiment.

FIG. 34 is a rear-side view of a canister having an agitation object of a touchless food service system of FIG. 1, according to an exemplary embodiment.

FIG. 35 is a rear cross-sectional view of a canister having an agitation object of a touchless food service system of FIG. 1, according to an exemplary embodiment.

FIG. 36 is a front view of an agitation object of a touchless food service system of FIG. 1, according to an exemplary embodiment.

FIG. 37 is a front view of another agitation object of a touchless food service system of FIG. 1, according to an exemplary embodiment.

FIG. 38 is a front view of a module of a touchless food service system of FIG. 1, according to an exemplary embodiment.

FIG. 39 is a front view of a motor housing of a touchless food service system of FIG. 1, according to an exemplary embodiment.

FIG. 40 is a front view of a motor housing coupled to a plurality of canisters of a touchless food service system of FIG. 1, according to an exemplary embodiment,

FIG. 41 is a user interface of an interface system of the touchless food service system of FIG. 1, according to an exemplary embodiment.

FIG. 42 is another user interface of an interface system of the touchless food service system of FIG. 1, according to an exemplary embodiment.

FIG. 43 is another user interface of an interface system of the touchless food service system of FIG. 1, according to an exemplary embodiment.

FIG. 44 is another user interface of an interface system of the touchless food service system of FIG. 1, according to an exemplary embodiment.

FIG. 45 is a block diagram of a food service system of the touchless food service system of FIGS. 1-44, according to an exemplary embodiment.

FIG. 46 is a flow diagram of a process for providing a food service, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

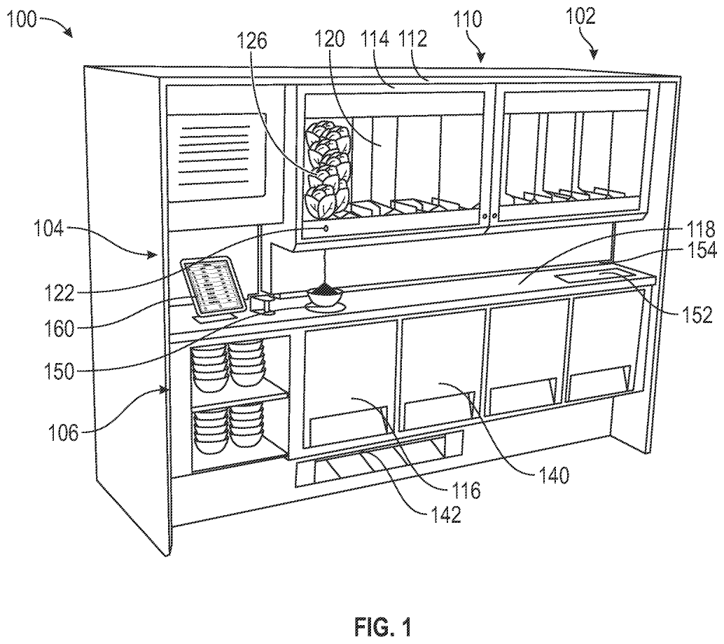

Referring generally to FIGS. 1-5, a touchless food service system is shown according to an exemplary embodiment. In an exemplary embodiment, the touchless food service system 100 (hereinafter “TFS system 100”) includes a food service apparatus 102, an interface system 104, and a tableware supply system 106. The TFS system 100 may be configured to provide a touchless (e.g., minimal contact, reduced contact, minimal user-food interaction, reduced user-food interaction, etc.) self-service food service that provides users with various food products (e.g., salad, dry goods, cereal, soup, yogurt, fruit, vegetables, frozen foods, noodles, grains, meals, entrees, drinks, warm food products, hot food products, ambient food products, frozen food products, chilled food products, condiments, etc.), while reducing the interaction between the food products and the user. In this regard, the TFS system 100 may provide a more sanitary (e.g., less user-food interaction, less or no cross-contamination of different foods, etc.) self-service food system.

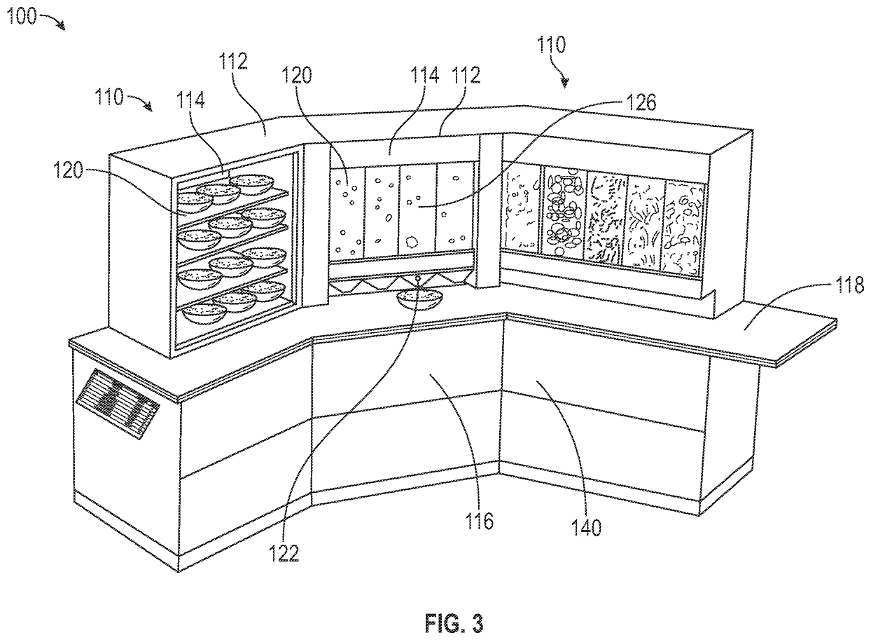

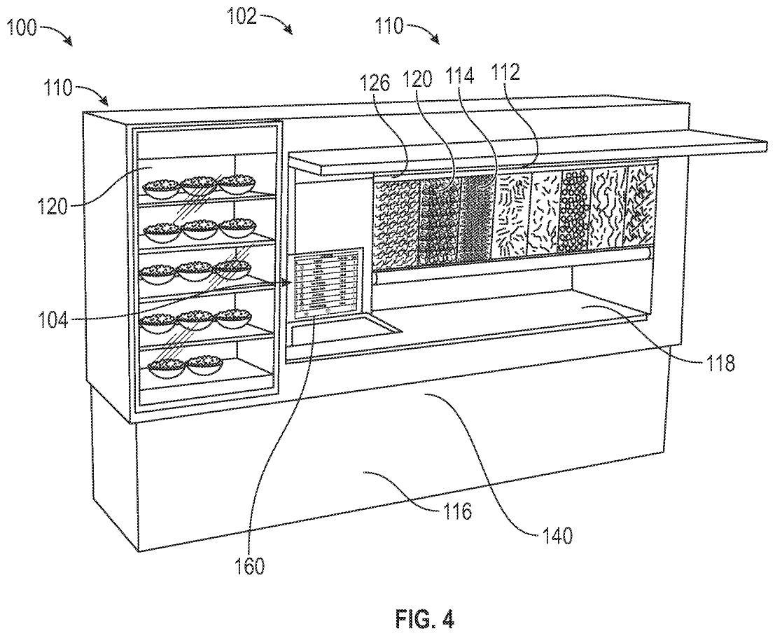

Referring now to FIG. 1, in an exemplary embodiment the food service apparatus 102 includes a module apparatus 110, or a plurality of module apparatuses 110 (hereinafter “module 110”). The module 110 includes a first housing 112 (cabinet, enclosure, etc.) with a door 114, a second housing 116 (cabinet, enclosure, etc.), and a counter 118. According to an exemplary embodiment, the first housing 112 includes a first enclosure (or cabinet) 120 and a sensor 122. The first enclosure 120 may be a temperature controlled enclosure (e.g., heated, refrigerated, ambient, etc.) configured to house a canister 126 (or a plurality of canisters 126) containing food products. In an exemplary embodiment, the first enclosure 120 is a linear arrangement, such that the contents of the first enclosure 120 (e.g., the canister 126, the plurality of canisters 126, food products within the canister 126, etc.) may be viewed by a user from outside the first enclosure 120. In an exemplary embodiment shown in FIGS. 3-4, the first enclosure 120 includes shelves configured to store food products, tableware, prepared dishes, etc., which may also be viewed by a user from outside the first enclosure 120. The sensor 122 may be a proximity sensor, a light sensor, and/or any other suitable sensor, and may be configured to sense when a piece of tableware (e.g., a bowl, a plate, a basket, etc.) is positioned below the first housing 112. In some embodiments, the sensor 122 is a weight sensor, and is configured to weigh a piece of tableware, a food product, a dish, etc. In some embodiments, the sensor 122 is a switch (e.g., a mechanical or electromechanical switch, manual switch, automated or semi-automated switch, etc.), which a user may manipulate in order to manually dispense food products. In other embodiments, the first housing 112 does not include the sensor 122. Also according to an exemplary embodiment, the door 114 includes a dividing surface 130 and a lock 132.

According to an exemplary embodiment, the second housing 116 includes a second enclosure (or cabinet) 140 and a first user interface (shown as a foot pedal 142). The second enclosure 140 may be configured to house various food service supplies (e.g., kitchen supplies, tableware supplies, cleaning supplies, etc.), refuse receptacles, or other food service components (e.g., a compressor of a refrigeration system, mechanical and/or electrical components, etc.). Further, the foot pedal 142 may be a touch pedal, a lever, a proximity sensor, a weight sensor (or any other suitable sensor and/or actuator), and may be configured to actuate dispensing food products from the first housing 112. In some embodiments, the foot pedal 142 includes a timer, and is configured to stop food products from being dispensed from the first housing 112 after a predetermined period of time (e.g., 10 seconds, 15 seconds, 1 minute, etc.), even if the user interface is still activated or receiving input. In some embodiments, the second housing 116 does not include the foot pedal 142.

According to an exemplary embodiment, the counter 118 also includes a positioning indicator 150 (or a plurality of positioning indicators 150), a second user interface (shown as an elbow actuator 152), and a refuse hole 154. The positioning indicators 150 may be positioned on the counter 118 at various locations beneath the first housing 112 (e.g., below each of the canisters 126 and/or the sensors 122, etc.), and may be configured to indicate where tableware should be positioned (e.g., placed, moved, etc.). The elbow actuator 152 may be a touch surface, proximity sensor, weight sensor (or any other suitable sensor, lever, and/or actuator), and may be configured to actuate dispensing food products from the first housing 112. In some embodiments, the elbow actuator 152 includes a timer, and is configured to stop food products from being dispensed from the first housing 112 after a predetermined period of time (e.g., 10 seconds, 15 seconds, 1 minute, etc.), even if the user interface is still activated or receiving input. The refuse hole 154 may be positioned at various locations on the counter 118, (e.g., along a back/inner edge of the counter 118, etc.) and may be configured to facilitate moving excess food products from the counter 118 to the second housing 116 (e.g., to a refuse receptacle housed therein). In some embodiments, the counter 118 includes a conveyer belt that is configured to manipulate (e.g., move, reposition, etc.) tableware such that the tableware may be selectively positioned at various locations beneath the first housing (e.g., selectively below each of the canisters 126 and/or the sensors 122, etc.). In other embodiments, the counter 118 includes a scale that is configured to weigh tableware, food products, dishes, etc., for example to be used in calculating the price of a food product, dish, etc.

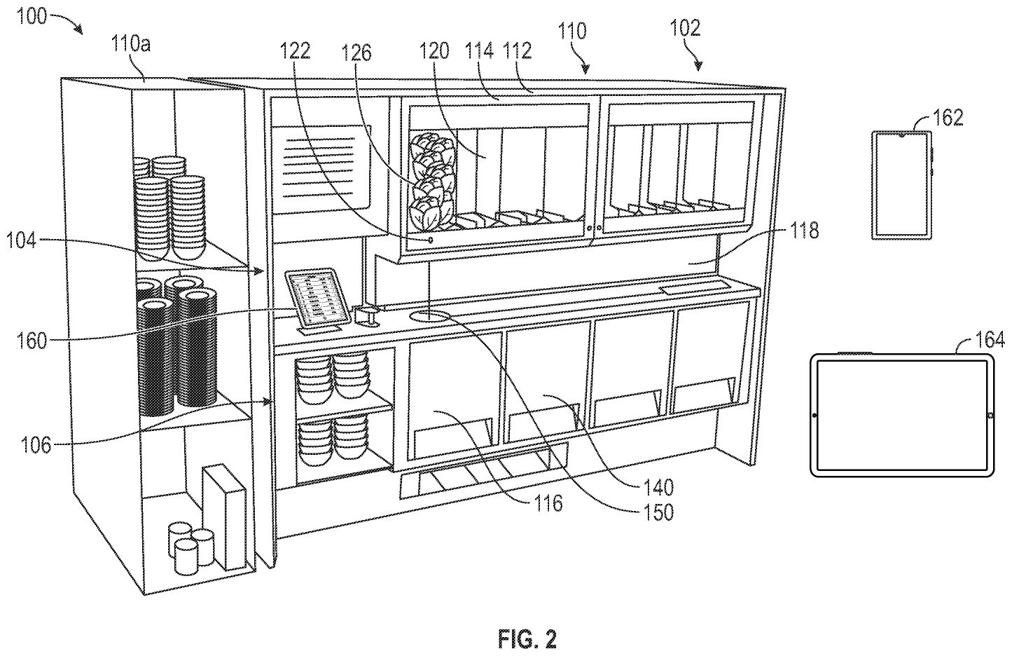

In some embodiments, the food service apparatus 102 also includes additional components that are configured to provide a touchless self-service food service. For example, in an exemplary embodiment shown in FIG. 2, the first housing 112, the second housing 116, and the counter 118 are combined into a storage system module (shown as storage module 110a). The storage module 110a may be configured as a temperature controlled module (e.g., chilled, heated, ambient, etc.), and may be configured to store excess food products, tableware, prepared dishes, or any other food preparation component that needs to be stored.

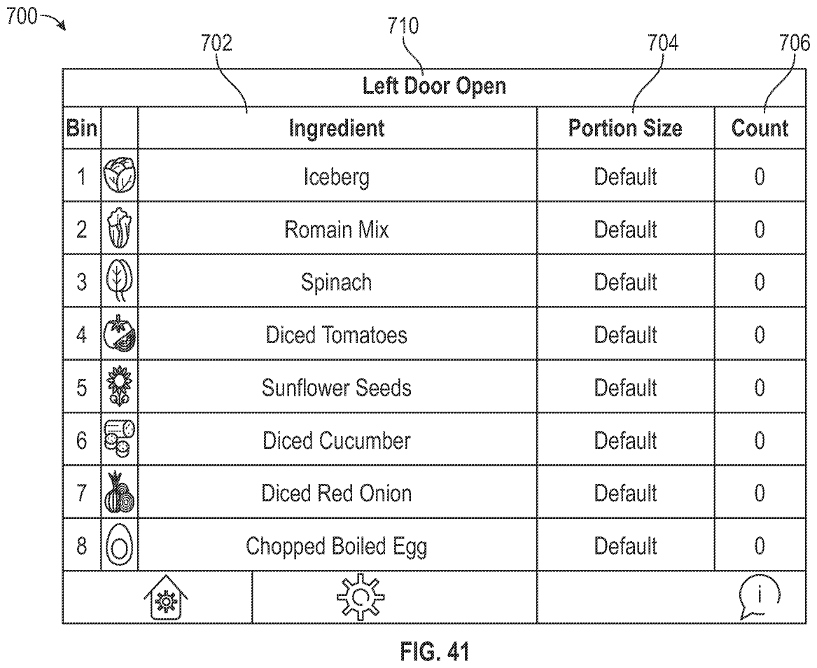

As shown in FIG. 1, the interface system 104 includes a merchant device 160, the sensor 122, the foot pedal 142, and the elbow actuator 152. The merchant device 160 may be any suitable electronic device (e.g., a mobile device, a laptop, a tablet, a touch screen, etc.), and may be configured to provide an interface for a user to interact with (e.g., via touchscreen, voice command, etc.), for example as shown in FIGS. 41-44. In some embodiments, the merchant device 160 is configured to communicate with other electronic devices (e.g., a user device such as a mobile phone, a network, a server, a controller, etc.) and/or receive input from the other devices (e.g., an order from a user device, a user application, a controller, etc.). As discussed briefly above, an actuator or activator, shown as the sensor 122, the foot pedal 142, the elbow actuator 152, and/or other input device, may be any suitable sensor, lever, button, and/or actuator configured to receive an input (e.g., via a user) and/or actuate dispensing a food product. According to an exemplary embodiment, the interface system 104 is configured to receive an input (e.g., from the sensor 122, from a user via the foot pedal 142, from a user via the elbow actuator 152, from a user via the merchant device 160, a user device, a user application, etc.), and in response, cause a food product to be dispensed from the first housing 112 (e.g., the canister(s) 126).

In some embodiments, the interface system 104 includes additional components that are configured to provide a touchless self-service food service. For example, in an exemplary embodiment shown in FIG. 2, the interface system 104 includes a payment module 162 and a weight module 164. In an exemplary embodiment, the payment module 162 is an electronic device (e.g., a mobile device, laptop, tablet, touch screen, etc.), and is configured to provide an interface for a user to interact with (e.g., via touchscreen, voice command, etc.). In some embodiments, the payment module 162 includes a printer, application interface, electric payment interface, cash payment interface, and/or any other suitable interface configured to provide food service information to a user (e.g., price, bill, coupons, etc.) and/or receive (e.g., process, etc.) a payment from a user. According to an exemplary embodiment, the weight module 164 is an electronic device (e.g., a mobile device, laptop, tablet, touch screen, etc.), and is configured to receive food product weight information (e.g., weight data, food product information, amount of time a sensor is activated, etc.) from the sensor 122, the foot pedal 142, the elbow actuator 152, a scale, or any other suitable device configured to determine the weight characteristics of a food product, dish, meal, etc. The weight module 164 may be configured to receive weight information, provide food service information (e.g., weight characteristics, etc.) to other components of the interface system 104 (e.g., the merchant device 160, the payment module 162, etc.), and/or receive a payment from a user.

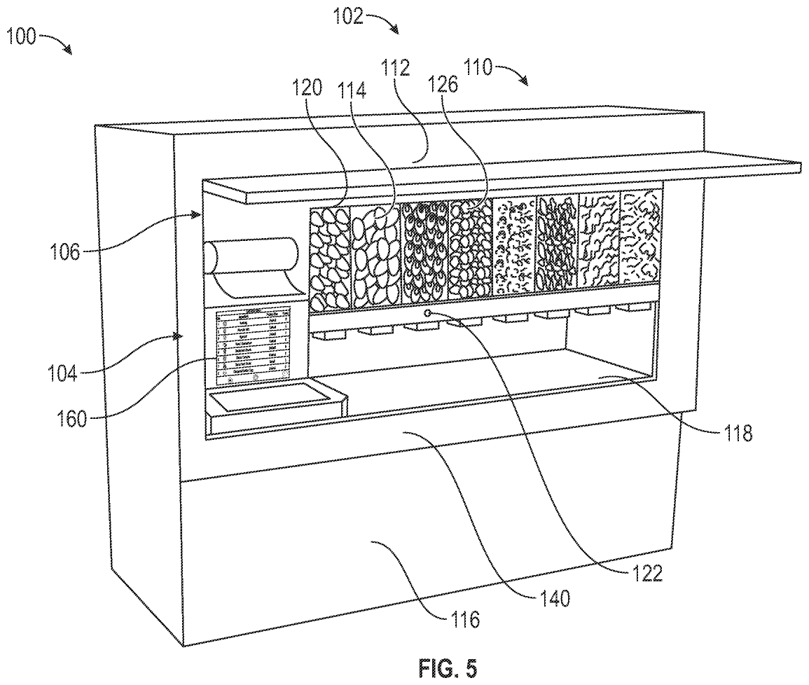

As shown in FIG. 1, the tableware supply system 106 is configured to accessibly hold any suitable tableware and/or kitchen supply. For example, the tableware supply system 106 may house, and allow a consumer to access, bowls, plates, baskets, utensils, napkins, condiments, etc. It should be understood that while only certain tableware (e.g., bowls) are shown in FIG. 1, this is not intended to be limiting, and any suitable tableware and/or kitchen supply may be used with the TFS system 100 of FIG. 1. For example, in an exemplary embodiment shown in FIG. 5, the tableware supply system 106 includes bags that are configured to house food products dispensed from the module 110.

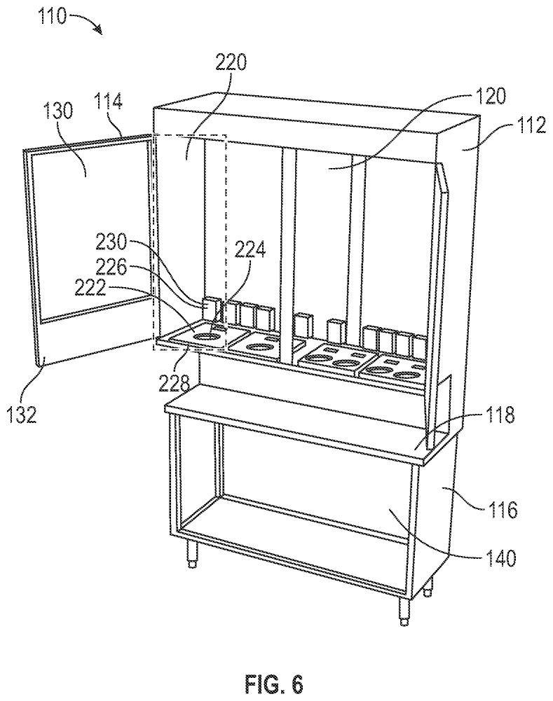

Referring now to FIG. 6, a module apparatus is shown according to an exemplary embodiment. For exemplary purposes, the module apparatus may be the module 110 of FIG. 1. As discussed briefly above, in an exemplary embodiment the module 110 includes the first housing 112 with the door 114, the second housing 116, and the counter 118. In some embodiments, the first housing 112, the second housing 116, and/or the counter 118 are combined as a single component. The module 110 may be of any suitable height, width, and depth to house any number of canisters 126 (e.g., three, four, six, etc.) of varying sizes (e.g., a half-size 7 quart canister, full-size 14 quart canister, 2 gallon canister, 3 gallon canister, 5 gallon canister, etc.). For example, in an exemplary embodiment the module 110 has a height of 61.5 inches (i.e., 156.5 cm), a width of 38 inches (i.e., 96.5 cm), and a depth of 15.5 inches (i.e., 39.5 cm). In other embodiments, the module 110 has a height of 61.5 inches (i.e., 156.5 cm), a width of 27.5 inches (i.e., 70 cm), and a depth of 15.5 inches (i.e., 39.5 cm). The first housing 112 may be positioned any suitable distance from the counter 118 (and/or the second housing 116), so as to eliminate excess open space between the first housing 112 and the counter 118 and/or provide space for a food product to be dispensed toward the second housing 116 (e.g., the counter 118, a piece of tableware on the counter 118, etc.). For example, the distance between the first housing 112 and the counter 118 may be 9 inches (i.e., 23 cm). In an exemplary embodiment, the module 110 is configured of any suitable sanitary materials, for example stainless steel and/or glass. In other embodiments, the module 110 is configured of other suitable materials (e.g., titanium, plastic, glass, rubber, wood, etc.). It should be understood that the module 110 may be configured with any suitable dimensions (e.g., height, width, depth, etc.), and may be made of any suitable sanitary materials.

As shown in FIG. 6, the first housing 112 includes the first enclosure 120, having one or more bays 220 (defined by one or more walls), a canister positioning bracket 222 having a first opening (shown as dispensing area 224), and a power supply module (shown as a power supply module 226). In an exemplary embodiment, the canister positioning bracket 222 is removably mounted at a lower portion of the bay 220 (e.g., a lower portion of the first enclosure 120 within the bay 220), and is configured to receive (e.g., hold, position, lock/release, etc.) the canister 126. The first opening (e.g., the dispensing area 224) may provide a space for a food product to be controllably dispensed from the first housing 112 toward the second housing 116, as discussed below. In an exemplary embodiment, the canister positioning bracket 222 also includes an aperture 228 (e.g., a slot, hole, space, slit, etc.) to allow passage and/or movement of air (e.g., chilled air, cold air, heated air, warm air, ambient air, etc.) along the canister positioning bracket 222 and/or components of the canister 126. According to an exemplary embodiment, the canister positioning bracket 222 is configured to receive one, two, or several of the canister(s) 126 (e.g., via tilting, tipping, pushing, etc.). In some embodiments, the canister positioning bracket 222 also includes lock/release mechanism(s) (e.g., latch, spring, pin, etc.), for example to lock/release the canister positioning bracket 222 in/from the first enclosure 120, and/or to lock/release the canister 126 in/from the canister positioning bracket 222.

As shown in FIG. 6, the power supply module 226 also includes a mounting interface 230 (or a plurality of mounting interfaces 230), and is mounted at the lower and rear portion of the bay 220 (e.g., the lower and rear portion of the first enclosure 120 within the bay 220). The mounting interface 230 may be configured to engage the canister 126 (or components of the canister 126), such that the canister 126 may be removably mounted in the bay 220 (e.g., the first housing 112). In an exemplary embodiment, the power supply module 226 is configured to provide power to components of the canister 126 (or components of the plurality of canisters 126) to controllably dispense a food product, as discussed below. Similar to the canister positioning bracket 222, the power supply module 226 may include lock/release mechanism(s), and is configured to receive (e.g., connect, engage, power, lock/release) the canister 126, or a plurality of canisters 126 (e.g., via tilting, tipping, pushing, etc.).

As shown in FIG. 6, the first enclosure 120 includes a plurality of bays 220, having any suitable combination of canister positioning brackets 222 and/or canisters 126. For example, in an exemplary embodiment the first enclosure 120 includes four bays 220, including a first and a second bay having a first and a second canister positioning bracket that receive one canister each (e.g., a full canister each), and a third and a fourth bay having a third and a fourth canister positioning bracket that receive two canisters each (e.g., two half canisters each). In another exemplary embodiment, the first enclosure 120 includes three bays 220, including a first bay having a first canister positioning bracket that receives one canister (e.g., a full canister), and a second and a third bay having a second and a third canister positioning bracket that receive two canisters each (e.g., two half canisters each). In yet other embodiments, the first housing 112, the first enclosure 120, and/or the bay 220 may be a single (e.g., uniform) component.

As shown in FIG. 6, the first housing 112 also includes the door 114. The door 114 is hingedly coupled to the first housing 112, and is configured to rotate between an open position and a closed position. As shown in FIG. 6, when the door is in the open position, the first enclosure 120 (and the bays 220) is/are accessible (e.g., for loading/unloading the canisters 126, cleaning, changing the canister positioning brackets 222, etc.). When the door 114 is in the closed position, the first enclosure 120 (e.g., the first housing 112 and the door 114, in combination) may form a temperature controlled enclosure (e.g., the first enclosure 120 may be heated, refrigerated, include ambient air, etc.). In this regard, when the door 114 is in the closed position, the first housing 112 may include an area (e.g., the first enclosure 120) that is insulated/separated from open air and user interaction, and thus can be efficiently temperature controlled (e.g., held at a temperature different than ambient air temperature, held at a target temperature, held around a target temperature, etc.).

According to an exemplary embodiment, the door 114 also includes the dividing surface 130 and the lock 132. In an exemplary embodiment, the dividing surface 130 includes glass, or any other suitable transparent material (e.g., acrylic, etc.). In this regard, the dividing surface 130 may be configured to permit a user to view the contents of the first enclosure 120 (e.g., the canister 126, a plurality of canisters 126, a food product within the canister 126, etc.) from outside the first enclosure 120. In some embodiments, the dividing surface 130 also includes reflective material, electronic components, signage, an interface, etc. (e.g., on the exterior of the dividing surface 130). The lock 132 may be positioned at the forward portion of the door 114 (e.g., exterior of the door 114), and may be configured to lock and unlock the door 114. The lock 132 may be a manual lock, an automatic lock, a motion sensor lock, a lock with a pressure sensor, a lock with a temperature sensor, or any other suitable locking mechanism.

As shown in FIG. 6, the second housing 116 includes the second enclosure 140. In an exemplary embodiment, the second enclosure 140 houses additional food service equipment (e.g., a compressor of a refrigeration system, power equipment, cooling equipment, heating equipment, mechanical components, electrical circuitry, storage space, etc.) for use in combination with the components of the module 110. For example, the second enclosure 140 may include a compressor (e.g., a reciprocating, rotary, or centrifugal compressor of a refrigeration system, an air compressor, etc.), mechanical components (e.g., condenser, evaporator, expansion valve, fans, heat exchangers, refrigeration coils, motors, etc.), electrical circuitry, a single point connector, etc., which may be coupled to components of the first housing 112. In this regard, the food service equipment in the second enclosure 140 may provide power (e.g., 120 volts, 20 AMPS, etc.) and/or temperature controlled air (e.g., heated, cooled, ambient, etc.) to components of the first housing 112 (e.g., the first enclosure 120, the canisters 126, etc.). In some embodiments, the second enclosure 140 also houses additional tableware (e.g., bowls, plates, cleaning supplies, etc.), food service supplies (e.g., kitchen supplies, cleaning supplies, etc.), and/or refuse receptacles. In yet other embodiments, the second enclosure 140 also includes space for storage (e.g., storage for replacement food, drinks, etc.).

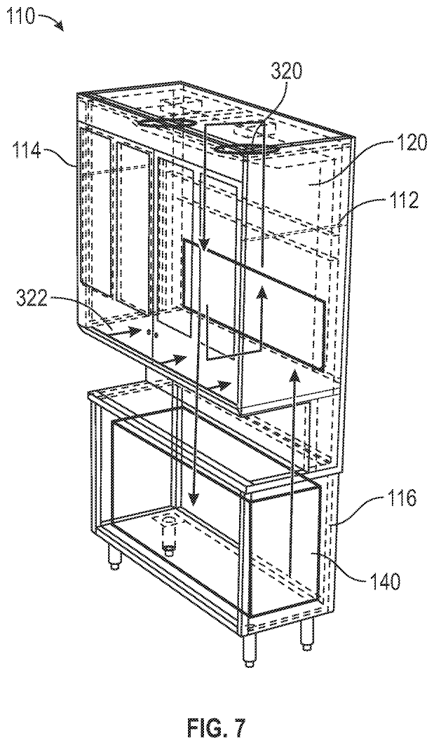

Referring now to FIG. 7, a module apparatus is shown according to an exemplary embodiment. For exemplary purposes, the module apparatus may be the module 110 of FIG. 1. As discussed above, in an exemplary embodiment the module 110 includes the first housing 112 (having the first enclosure 120) and the second housing 116 (having the second enclosure 140). In an exemplary embodiment, the first housing 112 (e.g., the first enclosure 120) includes a first fan (shown as a fan 320) and a second fan (shown as an air knife 322). The fan 320 and/or the air knife 322 may be any suitable fan configured to blow, move, circulate, etc. air. The fan 320 may be positioned along the upper portion of the first housing 112 (e.g., the center, laterally, etc.). In an exemplary embodiment, the fan 320 is configured to provide (e.g., blow, input, circulate, recycle, etc.) air to the first housing 112. In this regard, the fan 320 may provide air to the first enclosure 120, to/along the top/sides of the canisters 126, and/or to any other suitable component of the first enclosure (e.g., the aperture 228 of the canister positioning bracket 222, etc.), for example to keep the contents of the canister 126 at a controlled temperature. In an exemplary embodiment, the air knife 322 is positioned in the lower portion of the first housing 112 (e.g., forward in the center, forward laterally, rearward, etc.), and configured to provide (e.g., direct, blow, input, circulate, recycle, etc.) air to the first housing 112. When mounted in the first housing 112, the outlet portion of the base 506 of the canister 126 is positioned above the air knife 322 such that the air knife 322 insulates the canister 126 (and the food therein) from ambient air and maintain the temperature in the housing at a desired temperature. Alternatively, the air knife 322 may provide air to the first enclosure 120, to/along the bottom of the canisters 126, and/or to any other suitable component of the first enclosure 120 (e.g., through the aperture 228 of the canister positioning bracket 222, across the first opening or the dispensing area 224 of the canister positioning bracket 222, etc.), for example to keep the contents of the canister 126 at a controlled temperature. According to an exemplary embodiment, the fan 320 is configured to provide air in a first direction (e.g., vertically downward in the first housing 112), and the air knife 322 is configured to provide air in a second direction (e.g., horizontally rearward in the first housing 112). In other embodiments, the fan 320 is configured to move (e.g., draw, pull, circulate, recycle, etc.) air along a first path (e.g., vertically downward, vertically upward in the first housing 112), and the air knife 322 is configured to move (e.g., draw, blow, circulate, recycle, etc.) air along a second path (e.g., horizontally rearward in the first housing 112). It should be understood that the fan 320 and/or the air knife 322 may be configured to provide (e.g., blow, input, circulate, recycle, etc.) and/or move air to the first housing 112 in any suitable direction or combination of directions.

According to an exemplary embodiment, and as discussed above, the second housing 116 (e.g., the second enclosure 140) includes additional food service equipment (e.g., a compressor of a refrigeration system, mechanical components, electrical circuitry, etc.). In an exemplary embodiment, the food service equipment is configured to provide power and/or an output (e.g., chilled air, cold air, cooled air, heated air, hot air, warm air, ambient air, etc.) to other components of the module 110. In this regard, the equipment of the second enclosure 140 may provide temperature controlled air to the fan 320 and/or the air knife 322 (e.g., via tubes, piping, ducts, etc.). In an exemplary embodiment, the fan 320 and/or the air knife 322 are configured to receive chilled air from the second enclosure 140, and provide chilled air to the first housing 112. As discussed above, the fan 320 may provide chilled air in a first direction (e.g., vertically downward in the first housing 112, to/along the canisters 126, to the aperture 228 of the canister positioning bracket 222, etc.), and the air knife 322 may provide cold air in a second direction (e.g., horizontally rearward in the first housing 112, to/along the bottom of the canisters 126, through the aperture 228 and/or across the dispensing area 224 of the canister positioning bracket 222, to other components of the canisters 126, etc.) in order to refrigerate the contents of the first enclosure 120 (e.g., the canisters 126). In other embodiments, the fan 320 and/or air knife 322 are configured to receive/provide heated air (e.g., to heat the contents of the first enclosure 120, the canisters 126, etc.). In yet other embodiments, the fan 320 and/or the air knife 322 are configured to receive/provide ambient air. In some embodiments, the first housing 112 includes a plurality of fans 320 and/or a plurality of air knives 322. In yet other embodiments, the fan 320 and/or the air knife 322 are replaced by other suitable temperature control devices, for example tubes containing refrigerant, resistive heaters, induction warming coils, etc. It should be understood that in other embodiments additional food service equipment (e.g., a compressor of a refrigeration system, mechanical components, electrical circuitry, etc.) is housed within other components of the TFS system 100 (e.g., the module 110, the first housing 112, the first enclosure 120, etc.) such that power and/or an output is provided to, or contained within, components of the TFS system 100 (e.g., the first housing 112, the first enclosure 120, etc.).

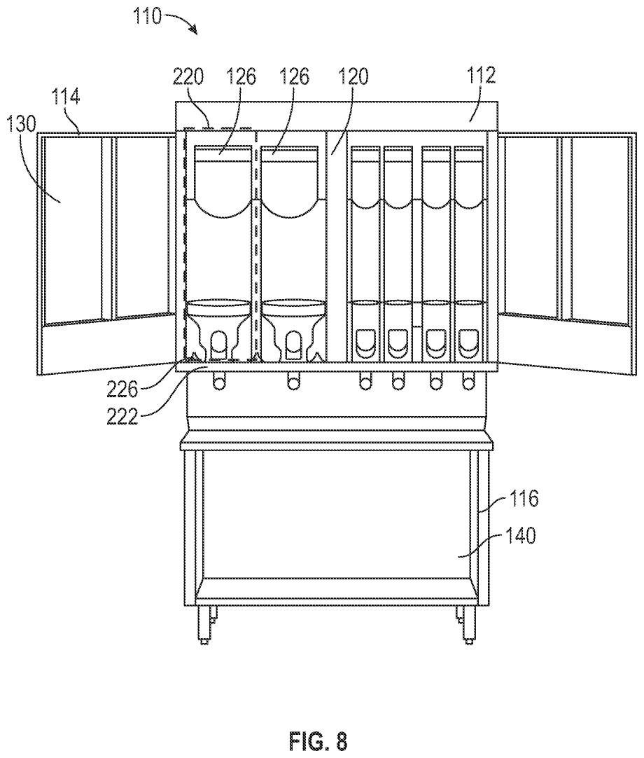

Referring now to FIG. 8, a module apparatus is shown according to an exemplary embodiment. For exemplary purposes, the module apparatus may be the module 110 of FIG. 1. As discussed above, in an exemplary embodiment the module 110 includes the first housing 112 (having the first enclosure 120) with the door 114, the second housing 116, and the counter 118. Also as discussed above, the first enclosure 120 is configured to house the canister 126, and as shown in FIG. 8, the first enclosure 120 is configured to house a plurality of canisters 126. In an exemplary embodiment, the first enclosure 120 is a linear arrangement, such that the contents of the first enclosure 120 (e.g., the plurality of canisters 126, food products within the plurality of canisters 126, etc.) may be viewed by a user from outside the first enclosure 120. The canister 126 may be positioned within the first enclosure 120 (e.g., in the bay 220), and may be configured to selectively couple the components of the first enclosure 120 (e.g., the canister positioning bracket 222, the mounting interface 230 of the power supply module 226, etc.). As shown in FIG. 8, the canister 126 (or a portion thereof) may extend below (e.g., through the dispensing area 224) the bay 220, the first enclosure 120, and/or the first housing 112. In this regard, components of the canister 126 may be outside the first housing 112 (e.g., the first enclosure 120 or the temperature controlled enclosure), and may be configured to dispense food products to a user. Also as shown in FIG. 8, the canister 126 (or a portion thereof) may be positioned within (and outside) the first enclosure 120 such that the canister 126 is separated from the second housing 116 and/or the counter 118 (e.g., by a vertical distance). In this regard, tableware may be placed at the second housing 116 and/or the counter 118, and the canister 126 may be positioned such that components of the canister 126 (e.g., an opening, etc.) are separated from the tableware, for example to reduce contact between components of the module 110 and/or reduce the risk of cross-contamination.

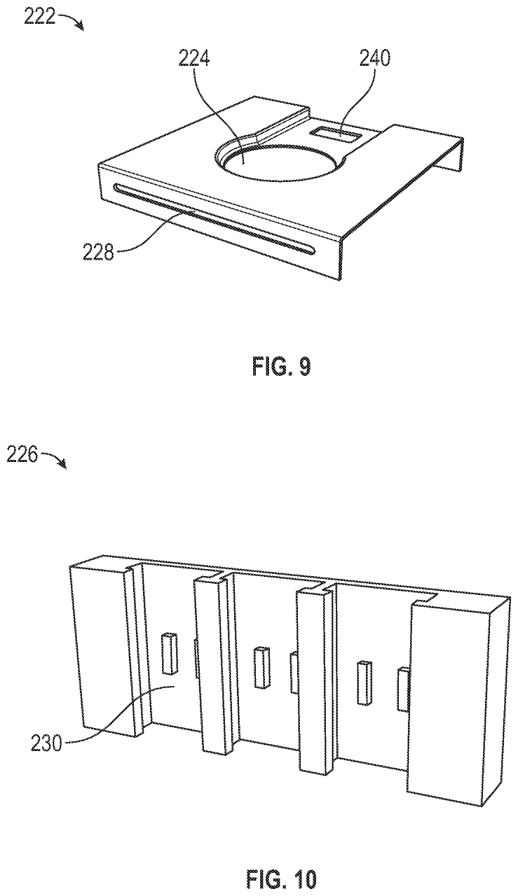

Referring now to FIG. 9, a canister positioning bracket is shown according to an exemplary embodiment. For exemplary purposes, the canister positioning bracket may be the canister positioning bracket 222 of FIG. 6. As shown in FIG. 9, the canister positioning bracket 222 includes a first opening (shown as the dispensing area 224), an aperture (shown as the aperture 228), and a second opening (shown as connection area 240). As discussed briefly above, the canister positioning bracket 222 may be removably mounted in the bay 220, and may be configured to receive (e.g., hold, position, lock/release, etc.) the canister 126. As shown in other figures, the canister positioning bracket may have a variety of widths to accommodate the desired setup. For example, two positioning brackets may be located in the same bay to align with two canisters mounted in that bay. The brackets may be separate discrete components or a single unitary integral bracket with an opening for each canister.

As shown in FIG. 9, the first opening (e.g., the dispensing area 224) is substantially circular and similar in size to an outlet of the canister 126. In other embodiments, the dispensing area 224 is any other suitable shape (e.g., square, rectangular, oval, etc.) and/or size. According to an exemplary embodiment, the dispensing area 224 provides a space for a food product to be controllably dispensed from the first housing 112 toward the second housing 116. In this regard, the dispensing area 224 permits a food product to pass from the bay 220 of the first housing 112 (e.g., the canister 126 in the first enclosure 120) toward the second housing 116 and/or a piece of tableware (e.g., tableware, dishware, serving dish, or the like positioned on the counter 118 or held below the openings).

As shown in FIG. 9, the aperture 228 is an elongated slot that is positioned at a forward portion of the canister positioning bracket 222 and proximate to the first opening (e.g., the dispensing area 224), shown as perpendicular to the central axis of the first opening. In other embodiments, the aperture 228 is another suitable shape (e.g., square, rectangular, circular, etc.) and/or may comprise any number of suitable apertures (e.g., one, two, three, five, etc.). According to an exemplary embodiment, the aperture 228 is configured to allow passage and/or movement of air (e.g., chilled air, heated air, ambient air, etc.) along or adjacent the canister positioning bracket 222 and/or components of the canister 126 (e.g., a base, etc.). For example, the aperture 228 may allow chilled air to pass across the dispensing area 224 to isolate the first housing 112 (e.g., the bay 220, the first enclosure 120, and/or the canister 126) from ambient air outside of the first housing 112. In addition, the aperture 228 may allow chilled air to pass along components of the canister 126 (e.g., a base, a receptacle, etc.). In this regard, the aperture 228 permits temperature controlled air (e.g., chilled, etc.) to pass across/along components of the first housing 112, such that the first housing 112 may form a temperature controlled enclosure.

As shown in FIG. 9, the second opening (e.g., the connection area 240) is a rectangular slot positioned at a rearward portion of the canister positioning bracket 222 and proximate to the first opening (e.g., the dispensing area 224). In other embodiments, the connection area 240 is another suitable shape and/or may comprise any number of suitable openings. According to an exemplary embodiment, the connection area 240 is configured to engage components of the canister 126 (e.g., a base, a drive motor module, etc.). In this regard, the connection area 240 enables the canister 126 to be adequately positioned and retained in place (e.g., relative to the dispensing area 224 of the canister positioning bracket 222, etc.) in the first housing 112. In other embodiments, the canister positioning bracket 222 does not include a connection area 240 and/or the connection area 240 does not engage components of the canister 126.

Referring now to FIG. 10, a power supply module is shown according to an exemplary embodiment. For exemplary purposes, the power supply module may be the power supply module 226 of FIG. 6. As shown in FIG. 10, the power supply module 226 includes a mounting interface 230 (or a plurality of mounting interfaces 230). As discussed briefly above, the power supply module 226 may be positioned at a lower portion of the bay 220, and may be configured to provide electrical power and/or an electrical signal to components of the canister 126 (e.g., a dispenser, etc.) such that the canister 126 controllably dispenses a food product. In some embodiments the power supply module 226 is permanently mounted in the first housing 112 (e.g., the bay 220). In other embodiments, the power supply module 226 is selectively mounted in the first housing 112 (i.e., can be replaced, cleaned, etc.).

As shown in FIG. 10, the mounting interface 230 are keyed passageways (e.g., grooves, channels, dovetail, etc.) configured to receive and engage components of the canister 126 (e.g., a drive motor, etc.), such that the mounting interface 230 enables the canister 126 to be adequately positioned and retained (e.g., relative to the dispensing area 224) in the first housing 112. The mounting interface 230 include electrical contacts that couple or engage with electrical contacts on the drive motor to deliver the electrical power and/or signals to the drive motor. In some embodiments, the power supply module 226 includes a single mounting interface 230. In other embodiments, the power supply module 226 includes a plurality of mounting interfaces 230. In this regard, the power supply module 226 may be configured to engage (e.g., mount, etc.) any suitable combination of canister(s) 126 (e.g., one canister, two canisters, three canisters, etc.) based on the number of mounting interface(s) 230 and desired system setup.

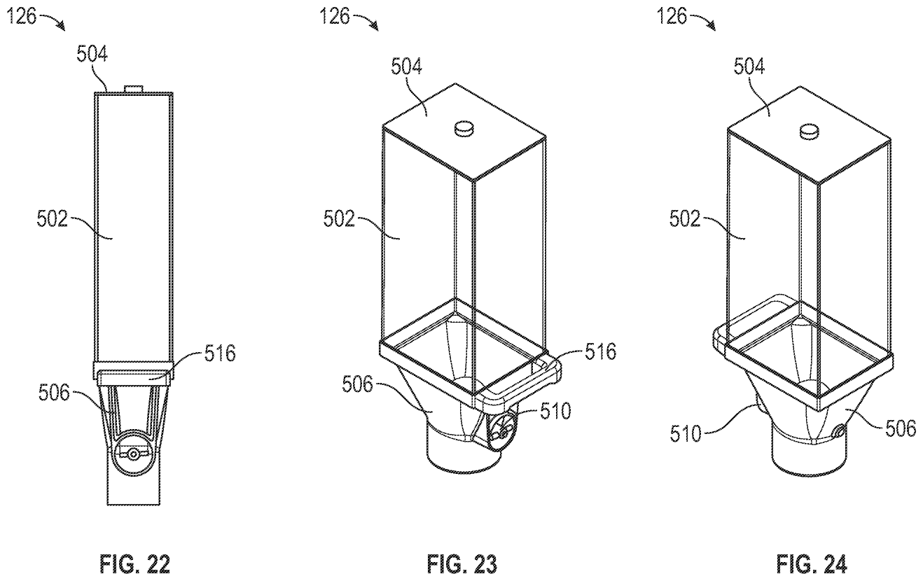

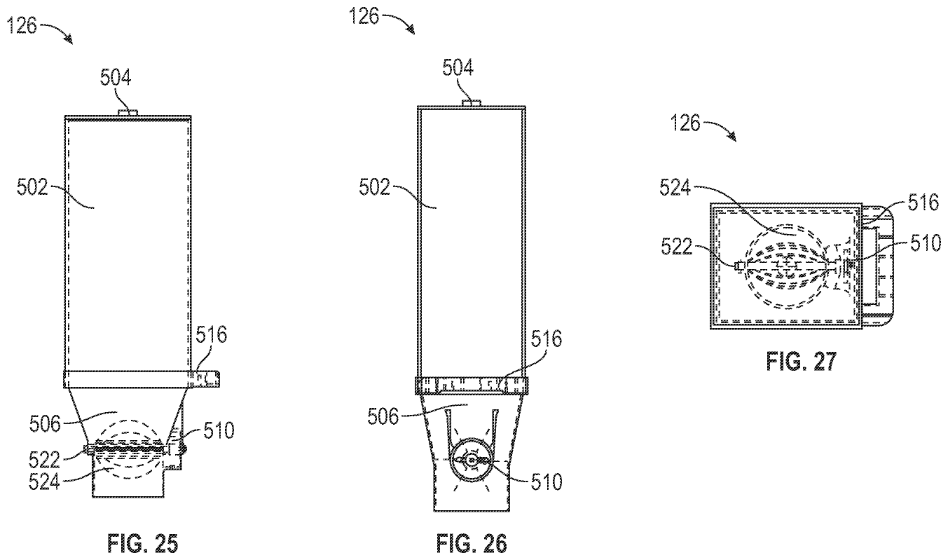

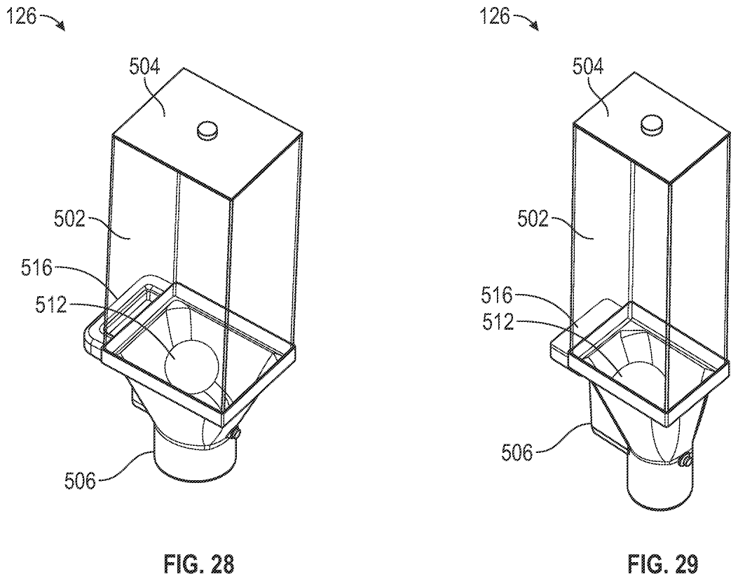

Referring generally to FIGS. 11-29, a canister is shown according to an exemplary embodiment. For exemplary purposes, the canister may be the canister 126 of FIG. 1. According to an exemplary embodiment, the canister 126 includes a receptacle 502, a canister lid 504, a base 506 (e.g., funnel, nozzle, etc.), a dispenser 508, and a drive motor module 510 (e.g., controller, etc.). In an exemplary embodiment, the canister 126 is configured to dispense food products in response to an input (e.g., manual user input, user input via a sensor, user input via a merchant device, user input via a mobile application, etc.).

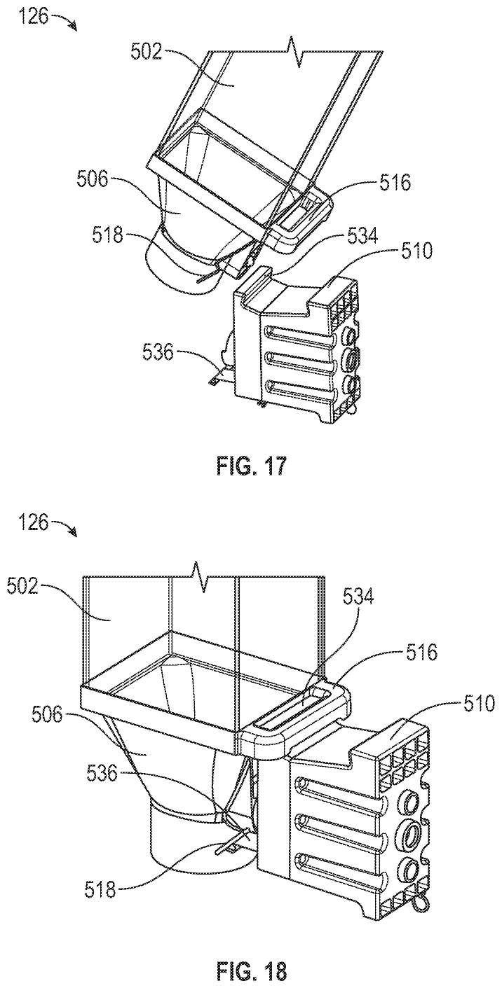

As shown in FIG. 11, the canister 126 includes the receptacle 502. The receptacle 502 may be a uniform receptacle or body of any suitable shape (e.g., cylinder, prism, circle, square, rectangular, etc.) and any suitable size (e.g., 7 quart, 14 quart, 2 gallon, 5 gallon, etc.). According to an exemplary embodiment shown in FIGS. 17-29, the receptacle 502 is a uniform rectangular prism. In other embodiments, the receptacle 502 is formed by two or more receptacle pieces (e.g., two, three, four), which can be coupled/de-coupled to/from one another to form the receptacle 502 shown in FIG. 11. In an exemplary embodiment, the receptacle 502 is made of any translucent or transparent sanitary material (e.g., polypropylene, polyethylene, etc.). In other embodiments, the receptacle 502 is made of other suitable materials (and/or may be colored). The receptacle 502 may be configured to receive, store, and provide food products (e.g., salad, soup, yogurt, fruit, vegetables, noodles, grains, drinks, etc.) until they are dispensed. For example, the receptacle 502 may be configured to receive food products at a first end of the receptacle 502 (e.g., an end proximate to the canister lid 504), store food products within the receptacle 502, and provide food products to other components at a second end of the receptacle 502 (e.g., an end proximate to the base 506).

As shown in FIG. 11, the canister lid 504 is positioned at the top of the receptacle 502, and is configured to be coupled/de-coupled to/from the receptacle 502 (e.g., during storage or use with the module 110, during loading/reloading of food products, during cleaning, etc.). Similar to the receptacle 502, in an exemplary embodiment the canister lid 504 is made of any suitable sanitary material (e.g., polypropylene, polyethylene, etc.); however, in other embodiments the canister lid 504 is made of other suitable materials (and/or may be transparent). The canister lid 504 may be configured to retain food products (e.g., salad, soup, yogurt, fruit, vegetables, noodles, grains, drinks, etc.) in the receptacle 502, and/or permit access to an interior portion of the receptacle 502. For example, after food products are loaded into the canister 126 (e.g., the receptacle 502), the canister lid 504 may couple to a first end of the receptacle 502 to retain the food products in the canister 126. Conversely, after food products have been dispensed from the canister (e.g., the receptacle 502, the base 506, etc.), the canister lid 504 may de-couple from the first end of the receptacle 502 to permit access (e.g., for re-loading, cleaning, disassembly, etc.) to the interior portion of the receptacle 502.

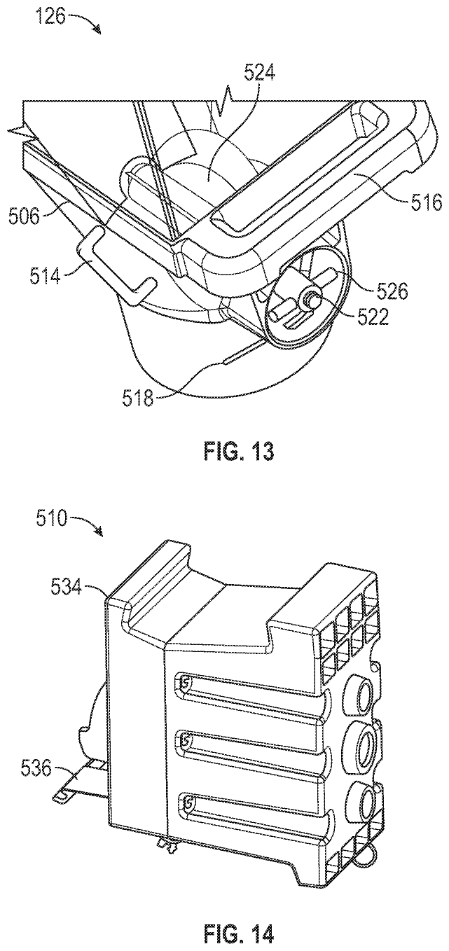

As shown in FIG. 11, the base 506 is positioned at the bottom of the receptacle 502, and is configured to receive food products from the receptacle 502. In an exemplary embodiment, the base 506 is configured to receive food products from the receptacle 502 at a first end of the base 506, and dispense food products from the base 506 at a second end (e.g., through an outlet, an opening, a slot, etc. and formed as a nozzle, funnel, etc.). Similar to the canister lid 504, the base 506 may couple/de-couple to/from the receptacle 502 (e.g., during storage or use, during reloading, during cleaning, etc.). The base 506 may also be made of suitable sanitary material (e.g., polypropylene, polyethylene, etc.); however, in some embodiments the base 506 is made of other suitable materials (and/or may be transparent). In some embodiments, the base 506 includes other components (e.g., a handle 514 as shown in FIG. 13, etc.) configured to aid in use, positioning, assembly, disassembly, transporting, etc. the canister 126. In yet other embodiments, the base 506 is a suitable shape and/or includes components that allow the canister 126 to be free-standing on a surface (e.g., a table, counter, shelf, etc.). According to an exemplary embodiment, the base 506 further engages (e.g., couple/de-couple to/from) other components of the module 110 (e.g., the connection area 240 of the canister positioning bracket 222, etc.). For example, when the canister 126 is positioned within the bay 220 of FIG. 6 and/or FIG. 8, the base 506 may engage (e.g., couple with, etc.) the connection area 240 of the canister positioning bracket 222, such that the second opening of the base 506 (e.g., the outlet, etc.) may be adequately positioned relative to the dispensing area 224 of the canister positioning bracket 222. In other embodiments, the base 506 does not engage the canister positioning bracket 222, and the second opening of the base 506 (e.g., the outlet, etc.) is adequately positioned relative to the dispensing area 224 via other configurations (e.g., components of the canister 126 and the mounting interface 230 of the power supply module 226).

As shown in FIG. 11, the canister 126 also includes the dispenser 508 and the drive motor module 510. As discussed in greater detail below, in an exemplary embodiment the dispenser 508 includes components that couple/de-couple to/from the base 506 and/or the drive motor module 510. The dispenser 508 may be configured to selectively or controllably dispense food products from the canister 126 (e.g., from the receptacle 502, the base 506, etc.), for example in response to an input (e.g., manual user input, user input via a sensor, user input via a merchant device, user input via a mobile application, etc.). In an exemplary embodiment, the drive motor module 510 also couples/de-couples to/from the base 506 and/or the dispenser 508 (as shown in FIGS. 17-18, shown below). The drive motor module 510 may be any suitable motor (e.g., electric motor, stepper motor, rotary actuator, etc.), and may be configured to drive (actuate, force, etc.) the dispenser 508 to controllably dispense food products from the canister 126.

In some embodiments, the drive motor module 510 includes a self-aligning connection for coupling the dispenser 508 and the drive motor module 510. The self-aligning connection may include a pin and a pin interface, a spindle and a receiving interface, an interface with a guiding component (e.g., a hole, an angled surface, etc.), or any other suitable self-aligning connection. According to an exemplary embodiment, the drive motor module 510 also engages (e.g., selectively couples to/de-couples from) other components of the first housing 112 (e.g., the bay 220, the connection area 240, the canister positioning bracket 222, the mounting interface 230, the power supply module 226, a motor housing, etc.). For example, when the canister 126 is positioned within the bay 220 (e.g., during loading, for use, etc.), the drive motor module 510 may couple with the connection area 240 of the canister positioning bracket 222 and/or the mounting interface 230 of the power supply module 226 in order to adequately position the canister 126 and/or receive an electric signal from the power supply module 226. Conversely, when the canister 126 is removed from the bay 220 (e.g., during unloading, cleaning, for refill, etc.), the drive motor module 510 may de-couple from the connection area 240 of the canister positioning bracket 222 and/or the mounting interface 230 of the power supply module 226 in order to remove the canister 126 and/or disconnect from the power supply module 226.

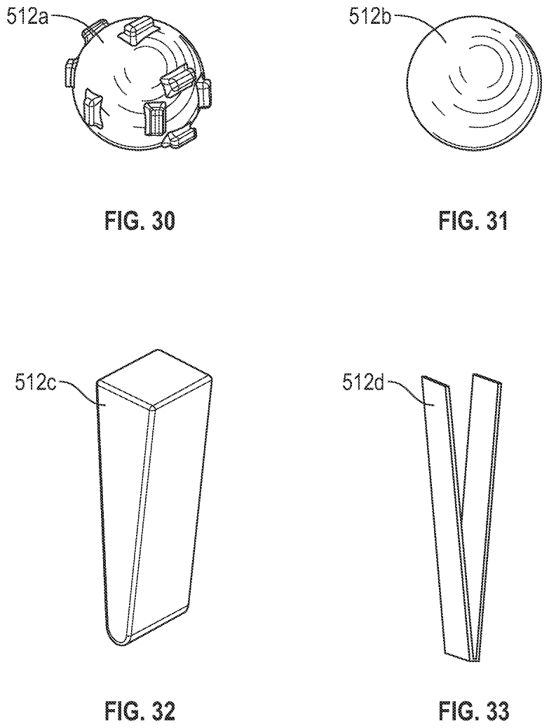

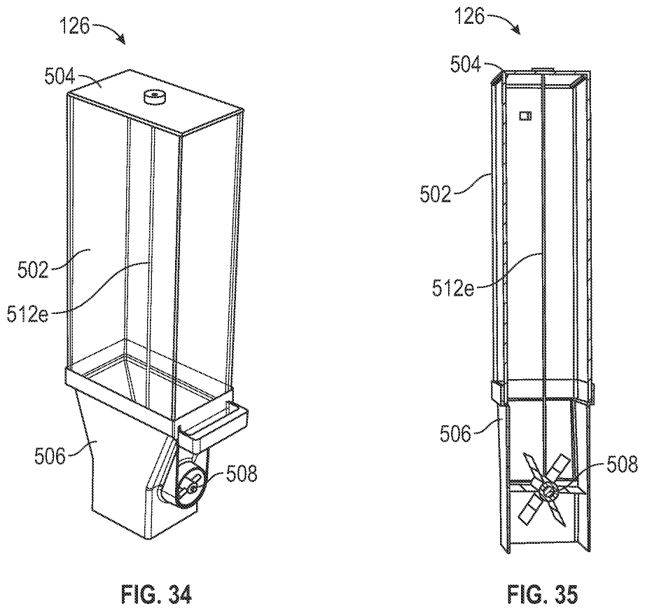

As shown in FIGS. 11-12 and 28-29, in some embodiments the canister 126 also includes an agitation object (e.g., shown as an agitation device or agitation object 512). According to an exemplary embodiment shown in FIG. 30, the agitation object 512a comprises a spherical body having a plurality of protrusions (e.g., nubs, bumps, bulges, etc.). In another embodiment shown in FIG. 31, the agitation object 512b is a unified body without additional structure (e.g., a spherical body without protrusions, nubs, ridges, texture, etc.). In another embodiment shown in FIG. 32, the agitation object 512c is a solid wedge. In another embodiment shown in FIG. 33, the agitation object 512d is a wedge with an open center. In yet another embodiment shown in FIGS. 34-37, the agitation object (e.g., the agitation object 512e, the agitation object 512f, etc.) is rigidly mounted to the canister 126 (e.g., the canister lid 504, the receptacle 502, the base 506, etc.). In other embodiments, the agitation object 512 is another suitable shape (e.g., a cylinder, a cube, prism, cone, pyramid, polyhedron, a circle, square, oval, etc.), and/or comprises other suitable structures (e.g., ridges, textured surface, etc.).

According to an exemplary embodiment, and as shown in FIGS. 11 and 28-29, the agitation object 512 is configured to be free-floating within the receptacle 502 and/or the base 506. The agitation object 512 may move (e.g., vertically up/down, laterally side to side, at an angle, or any combination thereof, etc.) within the receptacle 502 and/or the base 506, and may be configured to agitate (e.g., engage, contact, hit, couple, etc.) food products within the canister 126 such that the agitation object 512 aids in controllably dispensing food products from the canister 126. For example, the agitation object 512 may be configured to agitate (e.g., engage, contact, hit, etc.) sticky food products (e.g., leafy greens, etc.) to separate the food products with the canister 126. In this regard, the agitation object 512 may be configured to separate food products (e.g., from other food products, the receptacle 502, the base 506, the dispenser 508, etc.), and aid in controllably dispensing food products from the canister 126. In an exemplary embodiment, the agitation object 512 is also configured to selectively engage components of the dispenser 508 (e.g., a plurality of paddles, a lid, etc.) in order to agitate a food products within the receptacle 502.

In some embodiments, and as shown in FIGS. 34-35, the agitation object 512 (e.g., the agitation object 512e) is a rod that is rigidly mounted to the canister 126. In an exemplary embodiment, the agitation object 512e is a stainless steel rod of suitable diameter (e.g., ⅛ inch, ¼ inch, ½ inch, etc.), and is coupled to the canister lid 504 of the canister 126. The agitation object 512e may extend in a substantially vertical direction within the canister 126 (e.g., the receptacle 502, etc.), and may be configured to selectively engage components of the dispenser 508 to aid in controllably dispensing food products from the canister 126. For example, the dispenser 508 may include a plurality of paddles (e.g., a paddle wheel, etc.), which when rotated, may engage the agitation object 512e and/or manipulate the agitation object 512e (e.g., bend, flex, reposition, etc.). When the agitation object 512e is manipulated, the agitation object 512e may agitate (e.g., engage, contact, hit, couple, etc.) food products within the canister 126 such that the agitation object 512 separates food products (e.g., from other food products, the receptacle 502, the base 506, the dispenser 508, a plurality of paddles, etc.), and aids in controllably dispensing food products from the canister 126. In other embodiments, the agitation object 512e is mounted to another suitable component of the canister 126 (e.g., the receptacle 502, the base 506, the dispenser 508, etc.), is of another suitable length, is formed of another suitable material (e.g., plastic, etc.), and/or extends in another suitable direction (e.g., a substantially lateral direction, another angle, etc.).

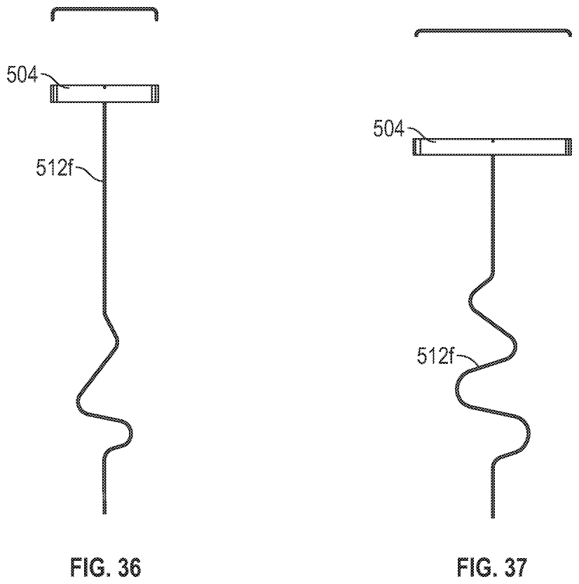

In other embodiments, and as shown in FIGS. 36-37, the agitation object (e.g., the agitation object 512f) is a rod that is mounted to the canister 126 (e.g., rigidly mounted, movably mounted, etc.). In an exemplary embodiment, the agitation object 512f is a rod having one or more curved sections (e.g., 1, 2, 3, 4, 5, etc.), and is coupled to the canister lid 504 of the canister 126. For example, the agitation object 512f may include one or more curved sections (shown as three curved sections in FIG. 36, as four curved sections in FIG. 37, etc.). In other embodiments, the agitation object 512f may include any suitable number of curved sections depending on the food being contained, dispensing preferences, etc. In an exemplary embodiment, the agitation object 512f extends in a substantially vertical direction within the canister 126 (e.g., from the canister lid 504, etc.), and/or is configured to selectively engage components of, and/or within, the canister 126. For example, the curved sections of the agitation object 512f may be configured to agitate (e.g., engage, contact, hit, etc.) sticky/tacky/clingy food products (e.g., leafy greens, etc.) to separate the food products within the canister 126. In some embodiments, an end of the agitation object 512f is configured to engage components of the dispenser 508 (e.g., a paddle, etc.), so as to manipulate the agitation object 512f (e.g., bend, flex, reposition, etc.) and aid in controllably dispensing food products from the canister 126, as discussed above. In this regard, the curved sections of the agitation object 512f may be configured to reposition within the canister 126, and/or agitate (e.g., engage, contact, hit, etc.) food products within the canister 126, to aid in controllably dispensing food products from the canister 126. In other embodiments, the agitation object 512f is mounted on another suitable component of the canister 126, includes another suitable number of curved and/or straight portions, is formed of another suitable material, and/or extends in another suitable direction.

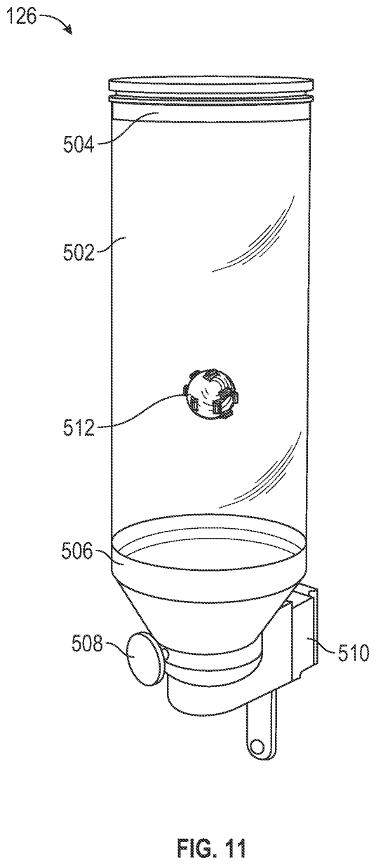

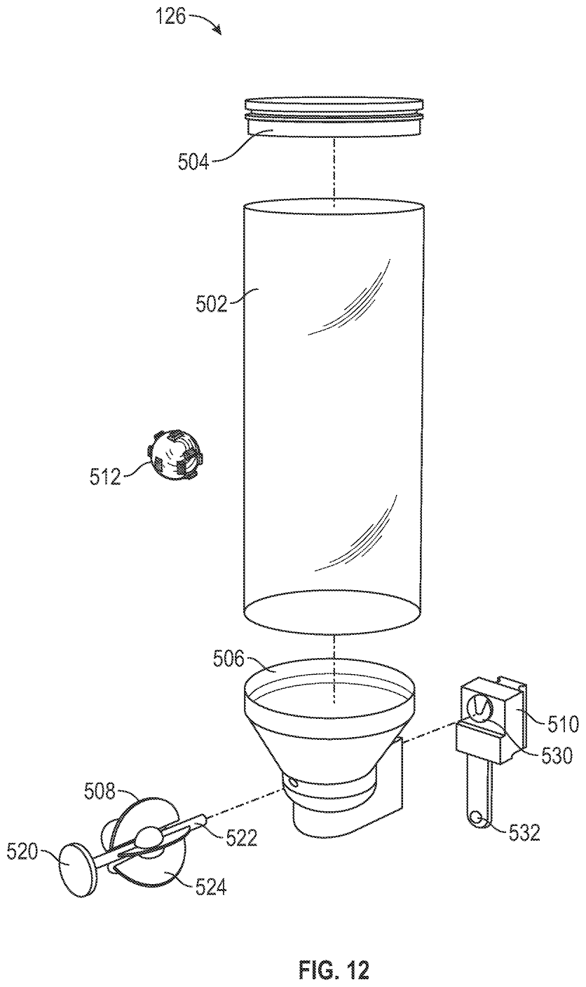

Referring now to FIG. 12, a canister is shown according to an exemplary embodiment. For exemplary purposes, the canister may be the canister 126 of FIG. 1 and/or FIG. 11. As discussed above, in an exemplary embodiment the canister 126 includes the receptacle 502, the canister lid 504, the base 506, the dispenser 508, and the drive motor module 510. The dispenser 508 may further include a knob 520, a spindle 522, and a plurality of paddles 524 (e.g., a paddle wheel). The drive motor module 510 may also include an engagement area 530 and a dispenser sensor 532.

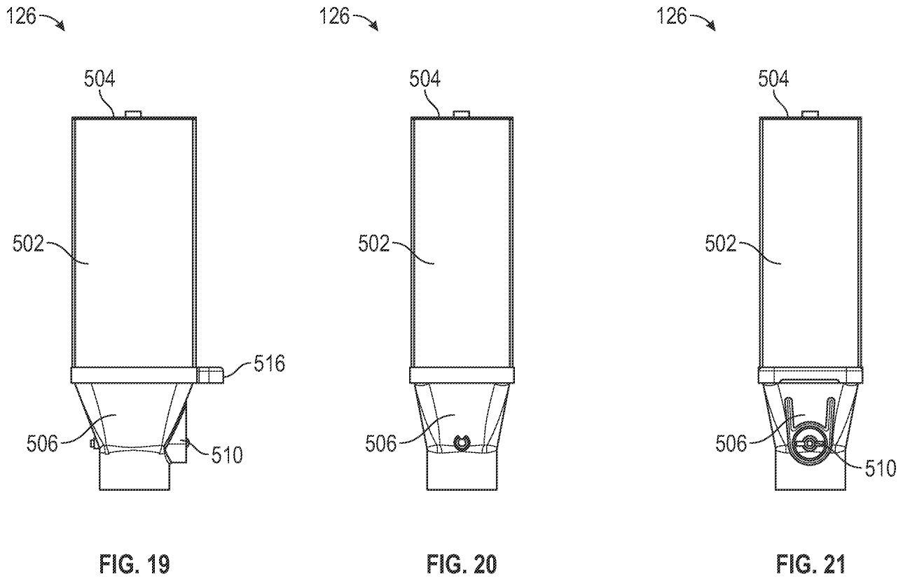

As shown in FIG. 12, in an exemplary embodiment the knob 520 is coupled to the spindle 522, and is positioned at the front of the base 506 (e.g., at the exterior, etc.). In some embodiments, the knob 520 is configured to be manipulated (e.g., rotated, pushed, pulled, etc. via a user, device, machine, controller, etc.) in order for the dispenser 508 to controllably dispense food products from the canister 126. In some embodiments, the dispenser 508 does not include the knob 520 (e.g., as shown in FIGS. 19-29). The spindle 522 may extend through the base 506 (e.g., via a hole, slot, slit, etc.), and may selectively couple/de-couple to/from the base 506 and/or the engagement area 530 of the drive motor module 510. The spindle 522 may also couple/de-couple the plurality of paddles 524, and form an axis of the plurality of paddles 524 (which may be positioned at the interior of the base 506). In some embodiments, the spindle 522 may form an axis that is positioned above a tapered portion of the base 506 toward the receptacle 502 (e.g., above a lower tapered portion of the base 506, above the entire tapered portion of the base 506, etc.). According to an exemplary embodiment, the spindle 522 is formed of a rigid material (e.g., metal, etc.), and the plurality of paddles 524 are formed of a soft and/or flexible material (e.g., 90 durometer plurality of paddles, plurality of paddles wall thickness of ⅛ inch, etc.). The plurality of paddles 524 may be any suitable shape (e.g., round, oval, rectangular, square, etc.), spacing between adjacent paddles, or size, and be in contact with the interior of the dispenser or be spaced apart from the interior of the dispenser, such that the plurality of paddles 524 may be configured to freely rotate within the base 506 and/or the receptacle 502. In this regard, the spindle 522 and/or the plurality of paddles 524 may be configured to be manipulated (e.g., rotated, pushed, pulled, etc. via the drive motor module 510, a device, another motor, a controller, etc.) in order for the dispenser 508 to controllably dispense food products from the canister 126.

According to an exemplary embodiment, the spindle 522 and/or plurality of paddles 524 are controllably rotated in a first direction in order for the dispenser 508 to dispense a food product. In other embodiments, the spindle 522 and/or the plurality of paddles 524 are otherwise manipulated (e.g., rocked back/forth, rotated in a first direction, rotated in a second direction, agitated, rotated at a first speed, rotated at a second speed, rotated for a set number of rotations, etc.) in order to selectively dispense a food product. In yet other embodiments, the spindle 522 and/or the plurality of paddles 524 are configured to selectively engage other objects (e.g., the agitation object 512, etc.) in order to agitate (e.g., dislodge, etc.) a food product within the receptacle 502. Although FIG. 12 shows the dispenser 508 as including a spindle 522 and plurality of paddles 524, it should be understood that any other suitable dispensing configuration may be incorporated in the dispenser 508. For example, the dispenser 508 may include a peristaltic tube, a pump (e.g., pressurized, peristaltic, syringe, air operated diaphragm, electric diaphragm, etc.), a hinged plate or tab, a pivotable plate, an auger, a gravity-fed plate or tab, a valve, a rotating wheel, a baffle, a flapper mechanism, etc., all of which may be configured to engage (e.g., couple/decouple, be powered by, be driven by, be controlled by, etc.) the base 506 and/or the drive motor module 510.

As shown in FIG. 12, the drive motor module 510 also includes the engagement area 530 and the dispenser sensor 532. As discussed briefly above, the engagement area 530 may be positioned at any suitable location on the drive motor module 510, and may be configured to engage (e.g., couple/de-couple, support, lock/release, etc.) components of the dispenser 508. According to an exemplary embodiment, the dispenser sensor 532 is positioned at the lower portion of the drive motor module 510, and is configured to sense an input (e.g., proximity of a piece of tableware, vibration, movement, weight, light, etc.). As shown in FIG. 12, the dispenser sensor 532 may be positioned below components of the canister 126 (e.g., an outlet of the base 506, the dispenser 508, etc.). In some embodiments, the dispenser sensor 532 is positioned below other components of the first housing 112 (e.g., the dispensing area 224 of the canister positioning bracket 222). In an exemplary embodiment, the dispenser sensor 532 is a proximity sensor; however, in other embodiments the dispenser sensor 532 is any suitable sensor (e.g., light, weight, motion, etc.), lever, button, and/or actuator (e.g., automatic actuator, manual actuator, etc.). As discussed in further detail below, in an exemplary embodiment the dispenser sensor 532 is configured to receive (e.g., sense, etc.) an input, and cause (e.g., activate, generate an electrical signal, etc.) the drive motor module 510 and/or the dispenser 508 to dispense food products from the canister 126. In some embodiments, the dispenser sensor 532 includes a timer, and is configured to stop the drive motor module 510 and/or the dispenser 508 from dispensing food products from the canister 126 after a predetermined period of time (e.g., 10 seconds, 15 seconds, 1 minute, etc.). In yet other embodiments, the dispenser sensor 532 is not part of the drive motor module 510; rather, dispenser sensor 532 is included in other components of the canister 126 (e.g., the base 506, etc.).

Referring now to FIG. 13, a base of a canister is shown according to an exemplary embodiment. For exemplary purposes, the canister may be the canister 126 of FIG. 1 and/or FIGS. 11-12. As shown in FIG. 13, the base 506 further includes a handle 514, a mounting or engagement hook 516, and an engagement aperture 518, and the dispenser 508 further includes a cross-pin 526 (e.g., cross-bar, cross-member, crosspiece, actuation member, rod, etc.).

As shown in FIG. 13, the handle 514 is positioned at a middle-side portion of the base 506, and is configured to be manipulated (e.g., held, secured, gripped, etc.) by a user in order to position, transport, move, etc. the canister 126. According to an exemplary embodiment, the handle 514 aids a user in positioning the canister 126 (e.g., in the module 110, the bay 220, at the power supply module 226, etc.) for use, replacement, refilling, etc., as well as, for transporting the canister 126. While the handle 514 is shown at a middle-side portion of the base 506 in FIG. 13, it should be understood that the handle 514 may be positioned at any other suitable position at the base 506 (e.g., a lower portion, an upper portion, a middle portion, a front portion, corners, top, etc.), and/or at any other suitable position on components of the canister 126 (e.g., the receptacle 502, etc.).

As shown in FIG. 13, the engagement hook 516 is positioned at an upper-rear portion of the base 506, and is configured to couple/de-couple components of the drive motor module 510. In an exemplary embodiment, the engagement hook 516 couples/de-couples (e.g., engages, hooks/un-hooks, locks/releases, etc.) a protrusion of the drive motor module 510 in order to connect/disconnect the base 506 to/from the drive motor module 510. In this regard, the engagement hook 516 (and a protrusion of the drive motor module 510) may be configured to ensure that the base 506 is securely coupled to the drive motor module 510. The engagement aperture 518 (e.g., a slit, etc.) is shown to be positioned at a bottom-rear portion of the base 506, and is also configured to couple/de-couple components of the drive motor module 510. In an exemplary embodiment, the engagement aperture 518 couples/de-couples (e.g., engages, receives/releases, locks/releases, etc.) a catch of the drive motor module 510 in order to position the base 506 relative to the drive motor module 510. In this regard, the engagement aperture 518 (and a catch of the drive motor module 510) may be configured to position the base 506 relative to the drive motor module 510 (e.g., to ensure secure engagement, etc.). It should be understood that while FIG. 13 shows the engagement hook 516 as a hook, and the engagement aperture 518 as a slit, the engagement hook 516 may be any configuration suitable to couple/de-couple the base 506 to/from the drive motor module 510 (e.g., a protrusion, pin, latch, spring, etc.), and the engagement aperture 518 may be any configuration suitable to position the base 506 relative to the drive motor module 510 (e.g., a slot, hole, space, etc.).

As shown in FIG. 13, the cross-pin 526 is coupled to a rearward portion of the spindle 522, and is oriented perpendicular to an axis of rotation of the spindle 522. In an exemplary embodiment, the cross-pin 526 couples to the spindle 522 (e.g., via a slit, pin, spring, etc.), and is configured to engage components of the drive motor module 510 (e.g., the engagement area 530). In this regard, in some embodiments the axis of rotation of the spindle 522 is perpendicular (e.g., via the cross-pin 526) to a face of the drive motor module 510 (e.g. the engagement area 530); however, in other embodiments, the axis of rotation of the spindle 522 is parallel to a face of the drive motor module 510 (e.g., the engagement area 530). According to an exemplary embodiment, the cross-pin 526 engages the engagement area 530, and is manipulated (e.g., rotated, etc. via the drive motor module 510, a device, another motor, a controller, etc.), causing the spindle 522, the plurality of paddles 524, etc. to rotate in order for the dispenser 508 to controllably dispense food products from the canister 126.

Referring now to FIGS. 14-16, a drive motor module of a canister is shown according to an exemplary embodiment. For exemplary purposes, the canister may be the canister 126 of FIG. 1 and/or FIGS. 11-13. As shown in FIGS. 14-16, the drive motor module 510 further includes a protrusion 534 (e.g., projection, hook, member, etc.), a catch 536, and a plurality of engagement components (e.g., shown as pins 538.

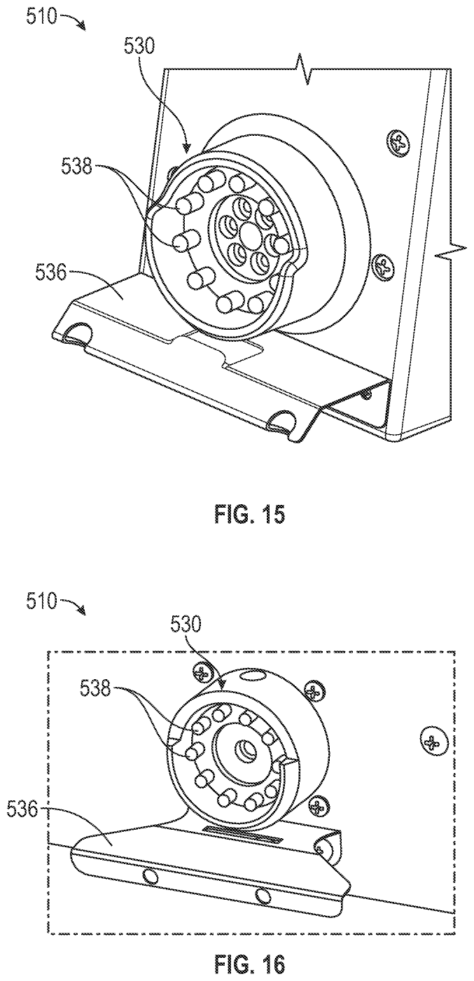

As shown in FIG. 14, the protrusion 534 is positioned at an upper-forward portion of the drive motor module 510, and is configured to couple/de-couple components of the base 506. As discussed above, in an exemplary embodiment, the protrusion 534 couples/de-couples (e.g., engages, hooks/un-hooks, locks/releases, etc.) an engagement component of the base 506 (e.g., the engagement hook 516) in order to connect/disconnect the drive motor module 510 to/from the base 506. The catch 536 (e.g., shown in FIG. 15) may be positioned at a bottom-forward portion of the drive motor module 510, and may also configured to couple/de-couple components of the base 506. In an exemplary embodiment, the catch 536 couples/de-couples (e.g., engages, receives/releases, locks/releases, etc.) an engagement area of the base 506 (e.g., the engagement aperture 518) in order to position the base 506 relative to the drive motor module 510. It should be understood that while FIGS. 14-16 show the protrusion 534 as a ridge, and the catch 536 as a plate (e.g., a spring plate), the protrusion 534 may be any configuration suitable to couple/de-couple the drive motor module 510 to/from the base 506 (e.g., a pin, latch, spring, lock, etc.), and the catch 536 may be any configuration suitable to position the base 506 relative to the drive motor module 510 (e.g., a pin, protrusion, block, etc.).

As shown in FIGS. 15-16, the engagement area 530 of the drive motor module 510 includes the plurality of engagement components (e.g., pins 538 coupled to a rotating driver or coupler mechanism. According to an exemplary embodiment, the plurality of pins 538 are positioned at a forward portion of the drive motor module 510 (e.g., the engagement area 530), and are oriented to face the base 506 and components of the dispenser 508 (e.g., the spindle 522, the cross-pin 526, etc.). The plurality of pins 538 may be any suitable shape (e.g., square, rounded, tapered, etc.), positioned at any suitable location at the engagement area 530 (e.g., in a circle, square, “X”, hexagonal, in a bunch, etc.), and may include any suitable number of pins (e.g., 5, 10, 15, etc.). For example, the plurality of pins 538 (shown in FIG. 15) may include rounded tips (e.g., to engage components of the dispenser 508, the cross-pin 526, etc.), may be positioned in a substantially circular shape at the engagement area 530, and may include 10 pins. In other embodiments, the plurality of pins 538 (shown in FIG. 16) are machined in a circular shape at the engagement area 530 and/or include 10 grooves. According to an exemplary embodiment, the plurality of pins 538 act as a follower in the rotating system and are configured to be manipulated (e.g., rotated, etc. via the drive motor module 510, a device, another motor, a controller, etc.), and engage the dispenser 508 (e.g., the spindle 522, the cross-pin 526, etc.) to cause the cross-pin 526, the spindle 522, and/or the plurality of paddles 524 to rotate in order for the dispenser 508 to controllably dispense food products from the canister 126. In this regard, the plurality of pins 538 are configured to engage the dispenser 508 (e.g., the spindle 522, the cross-pin 526, etc.), such that when the plurality of pins 538 are manipulated, the plurality of paddles 524 may rotate without slipping.

In some embodiments, the engagement area 530 includes fewer, additional, and/or different working components. For example, in some embodiments the pins 538 are another suitable engagement component (e.g., machine grooves, hooks, bolts, etc.) In other embodiments, the engagement area 530 includes an engagement interface. The engagement interface may be proximate to (e.g., central, etc.) the engagement components (e.g., pins 538, grooves 540, etc.), and/or may include components configured to engage the dispenser 508. In some embodiments, the engagement interface (shown in FIG. 15) includes one or more openings configured to receive a protrusion of the dispenser 508, so as to permit the dispenser 508 to rotate without slipping. In other embodiments, the engagement area (shown in FIG. 16) includes a substantially flat interface configured to engage (e.g., via friction, etc.) the dispenser, so as to permit the dispenser 508 to rotate without slipping. In yet other embodiments, components of the engagement area 530 are replaced by another suitable component configured to engage the dispenser 508 (e.g., a molded coupler, a textured surface, a scalloped surface, etc.). In other embodiments, the engagement components provide an engagement that imparts rotation to the spindle 522 in the dispenser when rotating in a first direction, and does not impart rotation to the spindle 522 when rotating in the opposite second direction (e.g., intentionally slips). In other embodiments, the engagement components provide an engagement that imparts rotation at a first rotational speed to the spindle 522 when rotating in a first direction, and imparts rotation to the spindle 522 at a second rotational speed that is different that the first rotational speed (e.g., faster, slower, etc.) when rotating in the opposite second direction.

Referring now to FIGS. 17-18, a canister is shown according to an exemplary embodiment. For exemplary purposes, the canister may be the canister 126 of FIG. 1 and/or FIGS. 11-16. As discussed above, in an exemplary embodiment, the base 506 is configured to couple/de-couple to/from the drive motor module 510, for example for use, refilling, replacement, cleaning, etc. As shown in FIGS. 17-18, the engagement hook 516 is configured to couple/de-couple (e.g., engage, hook/un-hook, lock/release, etc.) the protrusion 534, and the engagement aperture 518 is configured to couple/de-couple (e.g., engage, receive/release, lock/release, etc.) the catch 536. In an exemplary embodiment, the engagement hook 516 first couples the protrusion 534, such that the base 506 is positioned and/or secured relative to the drive motor module 510. The base 506 (and/or receptacle 502, etc.) may then be manipulated (e.g., rotated downward, repositioned downward, etc.), such that the engagement aperture 518 receives the catch 536. The base 506 (and/or receptacle 502, etc.) may then again be manipulated (e.g., repositioned downward, repositioned laterally, etc.), such that the engagement hook 516 and the protrusion 534 are securely coupled, the catch 536 is adequately coupled (e.g., positioned relative) to the engagement aperture 518, and the base 506 is adequately coupled and/or positioned relative to the drive motor module 510.

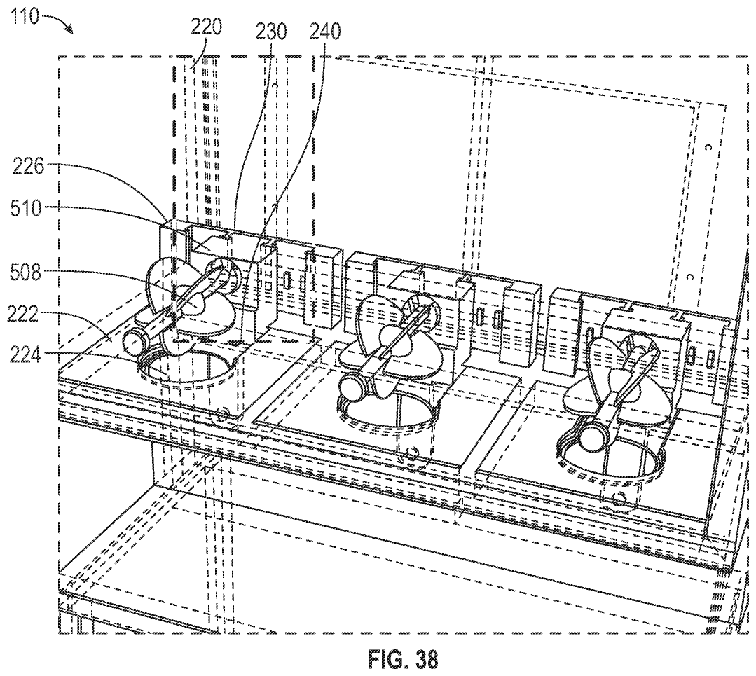

Referring now to FIG. 38, a module apparatus is shown according to an exemplary embodiment. For exemplary purposes, the module apparatus may be the module 110 of FIG. 1. As discussed above, the module 110 (e.g., the first enclosure 120) includes the bay 220 having the canister positioning bracket 222 (with the dispensing area 224 and the connection area 240) and the power supply module 226 (with the mounting interface 230). As shown in FIG. 38, in an exemplary embodiment the drive motor module 510 is configured to engage (e.g., selectively couple/de-couple to/from, etc.) the canister positioning bracket 222 and/or the power supply module 226. According to an exemplary embodiment, the drive motor module 510 is configured to selectively engage components of the canister positioning bracket 222 and/or the power supply module 226 in order to position the canister 126 and/or be setup/disassembled for use (e.g., engage for use, disengage for refill, replacement, cleaning, etc.). For example, when the canister 126 is positioned in the bay 220 (e.g., during loading, for use, etc.) the drive motor module 510 may be coupled with the connection area 240 of the canister positioning bracket 222 and/or the mounting interface 230 of the power supply module 226 in order to position the canister 126 and/or receive an electrical signal from the power supply module 226. In an exemplary embodiment, when the canister 126 is adequately positioned in the bay 220, components of the canister 126 (e.g., the second opening or outlet of the base 506, etc.) are adequately positioned (e.g., aligned) with components of the canister positioning bracket 222 (e.g., the dispensing area 224) and/or the power supply module 226. In other embodiments, when the canister 126 is being removed from the bay 220 (e.g., during unloading, cleaning, for refill, etc.), the drive motor module 510 may de-couple from the connection area 240 of the canister positioning bracket 222 and/or the mounting interface 230 of the power supply module 226 in order to remove the canister 126 and/or disconnect from the power supply module 226. In yet other embodiments, when the canister 126 is being removed from the bay 220, the drive motor module 510 may remain coupled with the canister positioning bracket 222 and/or the power supply module 226, and canister 126 components may be removed (e.g., the receptacle 502, the canister lid 504, the base 506, etc.). As shown in FIG. 38, in an exemplary embodiment the power supply module 226 (and/or the canister positioning bracket 222) is configured to receive a single drive motor module 510. However, in some embodiments the power supply module 226 (and/or the canister positioning bracket 222) is configured to receive a plurality of drive motor modules 510 (e.g., a plurality of canisters 126).

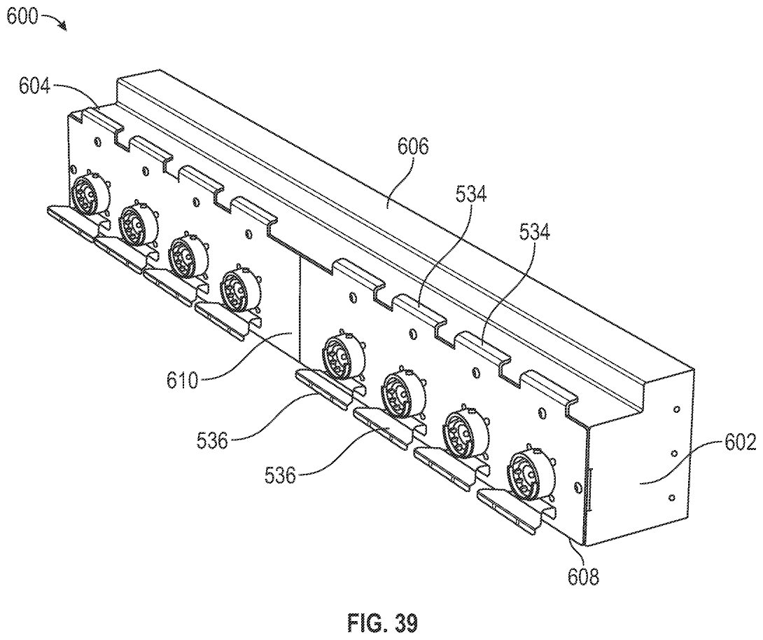

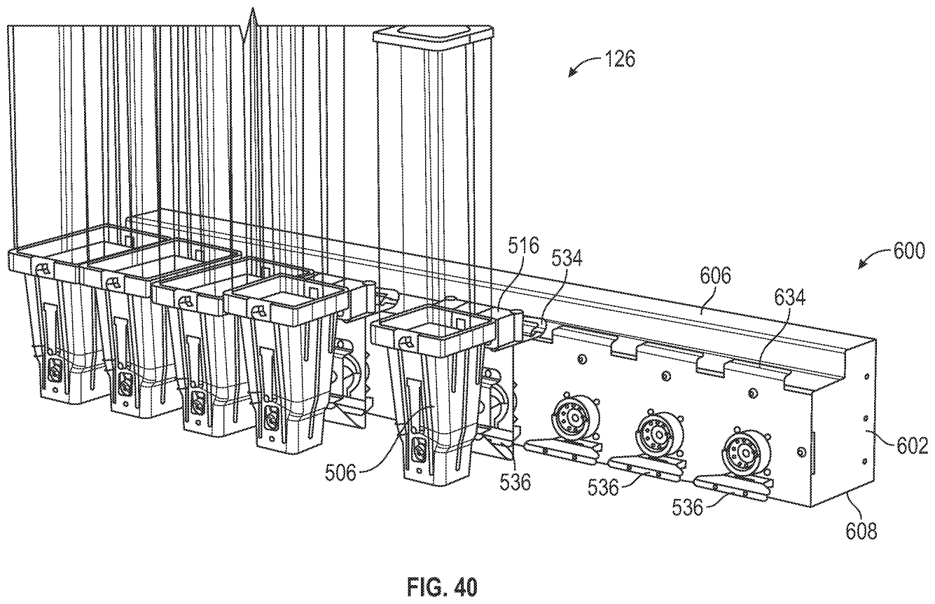

Referring now to FIGS. 39-40, a motor housing 600 is shown according to an exemplary embodiment. The motor housing 600 incorporates components of the TFS system 100, and/or is configured to house one or more drive motors (e.g., the drive motor modules 510). As shown in FIGS. 39-40, the motor housing 600 includes a first side wall 602, a second side wall 604, a top wall 606, a bottom wall 608, and a front wall 610, which define a space configured to house one or more drive motor modules 510. The motor housing 600 is coupled to a lower portion of the first enclosure 120, such that the motor housing 600 forms an enclosed space for the one or more drive motor modules 510 (e.g., via a back wall of the first enclosure 120). The motor housing 600 is shown as having a rectangular prism shape, and formed of a suitable sanitary material, for example stainless steel and/or glass. However, in other embodiments the motor housing 600 is of another suitable shape, formed of other suitable material, and/or positioned at another suitable location within the first enclosure 120.

As shown in FIGS. 39-40, the front wall 610 of the motor housing 600 includes a plurality of apertures (e.g., 2, 4, 8, 10, 12, etc. openings, cavities, voids, etc.) configured to receive one or more components of the drive motor module 510. As shown in FIG. 39, the motor housing 600 includes eight apertures spaced laterally (e.g., equally spaced, unequally spaced, staggered, offset, aligned, etc.) along the front wall 610, and the apertures are configured to receive the engagement area 530 of the drive motor module 510. In this regard, the apertures of the front wall 610 may permit the drive motor module 510 to be positioned substantially within the motor housing 600, while permitting the engagement area 530 to extend from the motor housing 600 (e.g., to couple the canister 126). In other embodiments, the motor housing 600 includes additional apertures, for example to permit other components of the drive motor modules 510 to extend from the motor housing 600 (e.g., the protrusion 534, the catch 536, etc.)

As shown in FIGS. 39-40, the motor housing 600 may also include other components of the TFS system 100. For example, the motor housing 600 may include one or more protrusions and/or one or more catches coupled to the front wall 610 (e.g., the protrusion 534 and the catch 536 of FIGS. 14-16). The motor housing 600 includes a plurality of protrusions 534 spaced along the front wall 610 (e.g., laterally spaced, equally spaced, aligned with the apertures, unequally spaced, etc.), and positioned at an upper portion of the front wall 610. As discussed above, the protrusions 534 may be configured to couple/de-couple (e.g., engage, hook/un-hook, lock/release, etc.) an engagement component of the base 506 (e.g., the engagement hook 516) in order to connect/disconnect the drive motor module 510 to/from the base 506 of the canister 126. In an exemplary embodiment, the motor housing 600 also includes a plurality of catches 536 spaced along the front wall 610 (e.g., laterally spaced, equally spaced, aligned with the apertures, unequally spaced, etc.), and positioned at a bottom portion of the front wall 610. As discussed above, the catch 536 may be configured to couple/de-couple (e.g., engage, receive/release, lock/release, etc.) an engagement area of the base 506 (e.g., the engagement aperture 518) in order to position the base 506 of the canister 126 relative to the drive motor module 510. It should be understood that while FIGS. 39-40 show the protrusion 534 as a ridge, and the catch 536 as a plate (e.g., a spring plate), the protrusion 534 may be any configuration suitable to couple/de-couple the drive motor module 510 to/from the base 506 (e.g., a friction contact surface, a pin, latch, spring, lock, etc.), and the catch 536 may be any configuration suitable to position the base 506 relative to the drive motor module 510 (e.g., a friction contact surface, a pin, protrusion, block, etc.).

As discussed above with regard to FIGS. 17-18, and as shown in FIG. 40, one or more canisters 126 may be configured to couple/de-couple to/from the drive motor module 510 (e.g., via the motor housing 600), for example for use, refilling, replacement, cleaning, etc. As shown in FIG. 40, the engagement hook 516 of the canister 126 is configured to couple/de-couple (e.g., engage, hook/un-hook, lock/release, etc.) the protrusion 534 of the motor housing 600, and an engagement aperture of the canister 126 is configured to couple/de-couple (e.g., engage, receive/release, lock/release, etc.) the catch 536 of the motor housing 600. The engagement hook 516 first couples the protrusion 534, such that the base 506 is positioned and/or secured relative to the drive motor module 510 (and/or the motor housing 600). The base 506 (and/or receptacle 502, etc.) may then be manipulated (e.g., rotated downward, repositioned downward, etc.), such that the engagement aperture receives the catch 536 of the motor housing 600. The base 506 (and/or receptacle 502, etc.) may then again be manipulated (e.g., repositioned downward, repositioned laterally, etc.), such that the engagement hook 516 and the protrusion 534 are securely coupled, the catch 536 is adequately coupled (e.g., positioned relative) to the engagement aperture, and the base 506 is adequately coupled and/or positioned relative to the drive motor module 510 and/or the motor housing 600.

Referring now generally to FIGS. 41-44, a plurality of interfaces are shown according to an exemplary embodiment. For exemplary purposes, the interfaces are user interfaces of the interface system 104 of FIG. 1. According to an exemplary embodiment, the interfaces are displayed on an electronic device (e.g., touch screen, tablet, mobile device, laptop, etc.), and are configured to provide an interface for a user to interact with (e.g., via touchscreen, voice command, etc.). In an exemplary embodiment, the interfaces are displayed on the second enclosure 140 (shown in FIG. 3), such that a user (e.g., merchant, owner, operator, etc.) may interact with the interfaces so as to control one or functions of the TFS system 100 (e.g., dispense food products, analyze utility and/or services information, run tests on one or more components of the TFS system 100, etc.), as discussed below. In other embodiments, the interfaces are displayed on another component of the interface system 104 (e.g., the merchant device 160 as shown in FIGS. 1-2, etc.) and/or another electronic device (e.g., a mobile device, laptop, etc.), such that a user (e.g., a merchant, employee, etc.) may interact with the interfaces to control one or more functions of the TFS system 100.

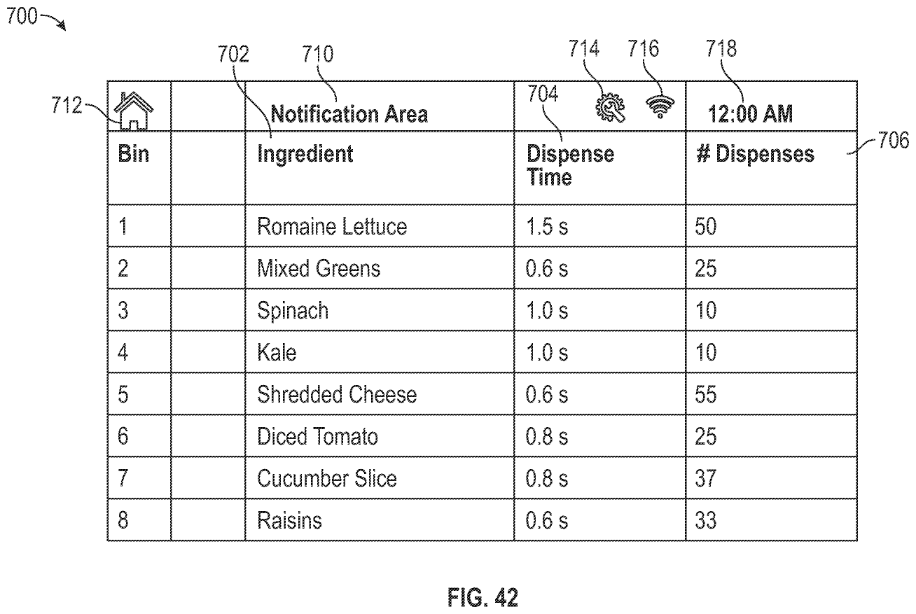

Referring now to FIGS. 41-42, a food dispensing interface, shown as dispensing interface 700, is shown according to an exemplary embodiment. In an exemplary embodiment, the dispensing interface 700 includes a food product indicator, shown as food icon 702, a serving size indicator, shown as size icon 704, and a serving amount indicator, shown as amount icon 706. A user may interact with the dispensing interface 700 (e.g., icons 702-704, etc.) so as to selectively dispense a specific amount of a food product. For example, a user (e.g., merchant, owner, etc.) may interact with the dispensing interface 700 and select the food icon 702 (e.g., “Ingredient” icon, etc.). By selecting the food icon 702, the dispensing interface 700 may display a list of food products available in the TFS system 100 (e.g., romaine lettuce, spinach, diced tomatoes, sunflower seeds, cucumbers, red onion, boiled eggs, raisins, etc.). The user may select the food icon 702 indicating the desired food product to be dispensed, and the dispensing interface 700 may display a list of serving sizes available for the food product. In some embodiments, the size icon 704 indicates the serving size via size indicators (e.g., small, default, large, etc.) as shown in FIG. 41. In other embodiments, the size icon 704 indicates the serving size via the length of time the selected food is dispensed (e.g., 0.2, 0.3, 0.4, 0.5, 0.6, 0.8, 1.0, 1.5, 2, etc. seconds) as shown in FIG. 42. In yet other embodiments, the size icon 704 indicates the serving size with the number and/or speed of rotations of the paddles of a canister, the direction of rotation of the paddles of a canister, the size of the paddles of a canister, and/or any other suitable dispensing characteristic. The user may select the size icon 704, and the TFS system 100 (e.g., the canister 126, etc.) may dispense the selected amount of the desired food. Such options for the food/ingredient, portion size, etc. may be preloaded to the user interface, inputted by the user, detected by the attached dispenser, etc. According to an exemplary embodiment, once the selected food has been dispensed the amount icon 706 is updated, so as to indicate the number of dispenses since the respective canister 126 has been refilled (e.g., as shown in FIG. 41). In some embodiments, to reset the amount icon 706 the dispensing interface 700 prompts the user for authentication (e.g., username, password, facial identification, identification, etc.) before granting access to components of the TFS system 100 (e.g., the canisters 126, etc.), so as to ensure appropriate access to components of the TFS system 100.

As shown in FIGS. 41-42, the dispensing interface 700 also includes a notification indicator, shown as notification icon 710. According to an exemplary embodiment, the notification icon 710 is configured to notify a user of a status of one or more components of the TFS system 100. For example, the notification icon 710 may provide a message to the user of a status of a component of the first enclosure 120 and/or the second enclosure 140 (e.g., a door, canister, fan, coolant, motors, etc.) as shown in FIG. 41. In some embodiments, the notification icon 710 provides a user an indication of the status of the food product within a canister 126 (e.g., temperature, amount of food product available, length of time food product has been in canister, etc.). In yet other embodiments, the notification icon 710 is configured to provide another suitable indication relating to a status of one or more components of the TFS system 100. As shown in FIG. 42, the dispensing interface also includes a home icon 712, which when interacted with may be configured to display a home interface to a user, and a settings icon 714, which when interacted with may be configured to display a settings interface to a user. In an exemplary embodiment, the dispensing interface 700 also includes an internet icon 716 configured to indicate whether one or more components of the TFS system 100 is/are connected to the internet, and a time icon 718 configured to display the time to a user.

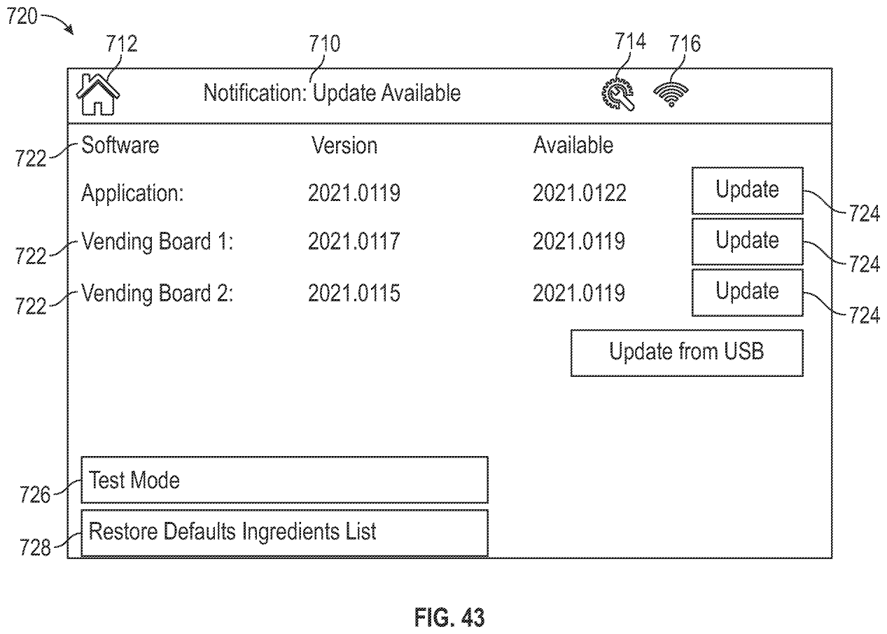

Referring now to FIG. 43, a utilities and/or software interface, shown as utilities interface 720, is shown according to an exemplary embodiment. In an exemplary embodiment, the utilities interface 720 includes one or more software icons 722 and one or more update icons 724. The software icon 722 may be configured to display information relating to the software status of one or more components of the TFS system 100 (e.g., software component, version, available updates, etc.). The update icons 724 may be configured to indicate whether a software update is available for the one or more versions of software (e.g., as indicated by the software icon, etc.) on a component of the TFS system 100. In an exemplary embodiment, a user may interact with the update icon 724, and the software of a component of the TFS system 100 may be updated (e.g., via internet, a network, a universal serial bus, etc.).

As shown in FIG. 43, the utilities interface 720 further includes a test mode icon 726 and a restore ingredient list icon, shown as restore icon 728. In an exemplary embodiment, a user may interact with the test mode icon 726, and the interface may display a test mode interface, as discussed below. In some embodiments, a user may interact with the restore icon 728, which may restore the amount icon 706 of the dispensing interface 700 to its default condition (e.g., zero, reset, etc.). As shown in FIG. 43, the utilities interface 720 may further include the notification icon 710, which may be configured to notify a user of a status of one or more components of the TFS system 100. For example, the notification icon 710 may be configured to notify a user that one or more software updates are available for one or more components of the TFS system 100. In an exemplary embodiment, the utilities interface 720 further includes the home icon 712, the settings icon 714, and the internet icon 716.

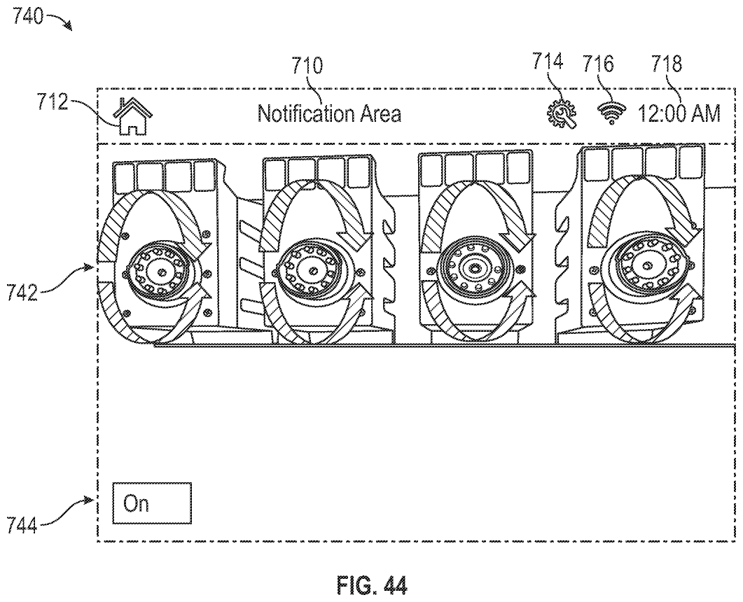

As shown in FIG. 44, a test mode interface, shown as test interface 740, is shown according to an exemplary embodiment. In an exemplary embodiment, the test interface 740 includes an instruction indicator, shown as instruction icon 742, and a status and infrared reading indicator, shown as status icon 744. The instruction icon 742 may be configured to communicate instructions for completing one or more tests on a component of the TFS system 100. For example, the instruction icon 742 may be a clockwise arrow and/or a counterclockwise arrow shown proximate to the engagement area 530 of the drive motor module 510, indicating a user may rotate the engagement area 530 clockwise/counterclockwise during a testing protocol. In an exemplary embodiment, the status icon 744 indicates the status of one or more components of the TFS system 100 (e.g., a switch of the canister 126, an infrared reading sensor, an infrared sensitivity sensor, etc.). As shown in FIG. 44, the test interface 740 may further include the notification icon 710, the home icon 712, the settings icon 714, the internet icon 716, and the time icon 718.

It should be understood that in other embodiments, the interfaces 700-740, and/or other interfaces, is/are configured to include additional, fewer, and/or different working components. For example, the interfaces 700-740 may display information relating to the TFS system 100, for example dispensed food product statistics (e.g., total, individual, etc. servings), on/off times, power consumption, etc. In other embodiments, the interfaces 700-740 display a copy of the owners and/or operators manual of one or more components of the TFS system 100 (e.g., canisters 126, etc.). In yet other embodiments, the interfaces 700-740 display troubleshooting and/or maintenance diagrams relating to one or more components of the TFS system 100. In some embodiments, the interfaces 700-740 display training videos and/or training diagrams relating to the use of one or more components of the TFS system 100 (e.g., canister removal, cleaning, repair, etc.). In yet other embodiments, the interfaces 700-740 display other suitable information and/or statistics relating to one or more components of the TFS system 100.

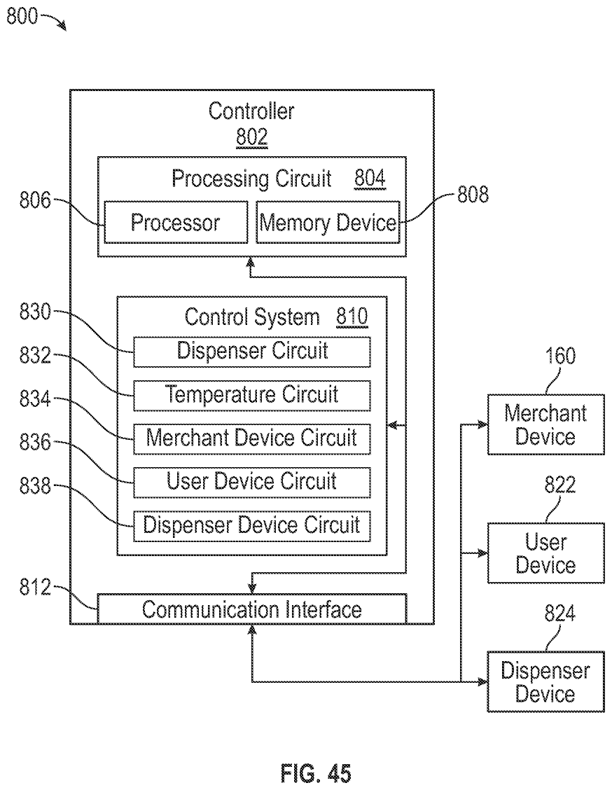

Referring now to FIG. 45 generally, a food service system 800 is shown according to an exemplary embodiment. In an exemplary embodiment, the food service system 800 may be incorporated in the TFS system 100 of FIG. 1. In other embodiments, the food service system 800 is structured as one or more electronic control units (ECU). Further, some of the components of FIG. 45 may be separate from, or included in, the control units and/or control modules of the TFS system 100 of FIG. 1 (e.g., mechanical and/or electrical components of the TFS system 100).

As shown in FIG. 45, the food service system 800 includes a controller 802 that may be communicably coupled with one or more external sources. The controller 802 includes a processing circuit 804 (having a processor 806 and a memory device 808), a control system 810 (having a plurality of circuits 830-838), and a communications interface 812. In an exemplary embodiment, the communications interface 812 is communicably coupled to one or more external sources, for example a merchant device 160, a user device 822, and/or a dispenser device 824. Generally, the controller 802 may be structured to receive, process, analyze, determine and/or send data relating to various components of a food service system (e.g., the TFS system 100 of FIG. 1).

Referring first to the controller 802, the controller 802 includes the processing circuit 804, having the processor 806 and the memory device 808. In an exemplary embodiment, the processing circuit 804 is structured or configured to execute or implement the instructions, commands, and/or control processes described herein with respect to the circuits (e.g., circuits 830-838) of the control system 810. The depicted configuration represents the circuits (e.g., circuits 830-838) of the control system 810 as machine or computer-readable media. However, this illustration is not meant to be limiting as the present disclosure contemplates other embodiments where the circuits (e.g., circuits 830-838) of the control system 810, or at least one circuit, is configured as a hardware unit. All such combinations and variations are intended to fall within the scope of the present disclosure.

As shown in FIG. 45, in an exemplary embodiment the processing circuit 804 includes the processor 806. According to an exemplary embodiment, the hardware and data processing components used to implement the various processes, operations, illustrative logics, logical blocks, modules and circuits described in connection with the embodiments disclosed herein (e.g., the processor 806) may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. In some embodiments, a general purpose processor may be a microprocessor, or, any conventional processor, or state machine. In an exemplary embodiment, the processor 806 may also be implemented as a combination of computing devices, such as a combination of a DSP and a microprocessor, a plurality of microprocessors, one or more microprocessors in conjunction with a DSP core, or any other such configuration. The one or more processors may be shared by multiple circuits (e.g., circuits 830-838 may comprise or otherwise share the same processor which, in some embodiments, may execute instructions stored, or otherwise accessed, via different areas of memory). Alternatively or additionally, the one or more processors may be structured to perform or otherwise execute certain operations independent of one or more co-processors. All such variations are intended to fall within the scope of the present disclosure.

Also shown in FIG. 45, in an exemplary embodiment the processing circuit 804 also includes the memory device 808. The memory device 808 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 808 may be communicably connected to the processor 806 to provide computer code or instructions to the processor 806 (and/or the processing circuit 804) for executing at least some of the processes described herein. Moreover, in an exemplary embodiment the memory device 808 may be or include tangible, non-transient volatile memory or non-volatile memory. Accordingly, the memory device 808 may include database components, object code components, script components, or any other type of information structure for supporting the various activities and information structures described herein.

As shown in FIG. 45, in an exemplary embodiment the control system 810 includes a plurality of circuits (e.g., circuits 830-838). In one configuration, the circuits 830-838 of the control system 810 are embodied as machine or computer-readable media that is executable by a processor, such as the processor 806. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the circuits (e.g., circuits 830-838) of the control system 810 may be embodied as hardware units, such as electronic control units. As such, the circuits (e.g., circuits 830-838) may be embodied as one or more circuitry components including, but not limited to, processing circuitry, network interfaces, peripheral devices, input devices, output devices, sensors, etc. In an exemplary embodiment, the circuits (circuits 830-838) may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the circuits (e.g., circuits 830-838) may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). In an exemplary embodiment, the circuits (e.g., circuits 830-838) may also include programmable hardware devices such as field programmable gate arrays, programmable array logic, programmable logic devices or the like. The circuits may include one or more memory devices for storing instructions that are executable by the processor(s) of the circuits (e.g., circuits 830-838). The one or more memory devices and processor(s) may have the same definition as provided below with respect to the memory device 808 and the processor 806. In some hardware unit configurations, the circuits (e.g., circuits 830-838) may be geographically dispersed throughout separate locations in a food service system (e.g., the TFS system 100 of FIG. 1, etc.). In an exemplary embodiment, and as shown in FIG. 45, the circuits (e.g., circuits 830-838) may be embodied in or within a single unit/housing, which is shown as the controller 802.

As discussed briefly above, in an exemplary embodiment the control system 810 includes a plurality of circuits. For example, the control system 810 may include a dispenser circuit 830, a temperature circuit 832, a merchant device circuit 834, a user device circuit 836, and dispenser device circuit 838. In an exemplary embodiment, the circuits of the control system 810 (e.g., circuits 830-838) receive data from, and/or send data to, an external device (e.g., the merchant device 160, the user device 822, the dispenser device 824, etc.) via the communications interface 812, the processing circuit 804 (e.g., the processor 806 and/or the memory device 808), and/or another circuit of the control system 810. Moreover, the circuits of the control system 810 (e.g., circuits 830-838) may be further configured to receive, process, analyze, determine, communicate, send, etc. data relating to various food service system components, as discussed below.

In an exemplary embodiment, the dispenser circuit 830 is configured to receive food request input data. According to an exemplary embodiment, the dispenser circuit 830 is configured to receive food request input data from an external device (e.g., an order from a touch screen, the merchant device 160, the user device 822, the dispenser device 824, etc.). In some embodiments, the dispenser circuit 830 receives food request input data from various components of a food service system (e.g., the TFS system 100 of FIG. 1, etc.). For example, the dispenser circuit 830 may receive food request input data from a sensor (e.g., the sensor 122 of the first housing 112, the foot pedal 142 of the second housing 116, the elbow actuator 152 of the counter 118, the dispenser sensor 532 of the canister 126, etc.), an interface (e.g., the interface 700 via the merchant device 160, electronics on the dividing surface 130, etc.), and/or any other suitable communications device (e.g., a voice command device, a motion sensor, a visual sensor, etc.). In yet other embodiments, the dispenser circuit 830 is configured to receive food request input data from other components of the food service system 800 (e.g., the merchant device circuit 834, the user device circuit 836, etc.). Based on the food request input data, the dispenser circuit 830 may be configured to determine the properties of a food request. For example, the dispenser circuit 830 may receive food request input data, and determine the properties (e.g., type of food, quantity of food, order of preparing food products, etc.) of the food request. In some embodiments, the dispenser circuit 830 determines the quantity of food to be dispensed or the speed that food is dispensed via the length of time a canister 126 dispenses food, the number and/or speed of rotations of the drive motor module 510, the direction of paddle rotation of a canister 126, the size and/or orientation of paddles relative to the configuration of a canister 126, and/or any other suitable dispensing characteristics. The dispenser circuit 830 may further be configured to communicate the food request properties to other components of the food service system 800 (e.g., the dispenser device circuit 838, the dispenser device 824, etc.) and/or other components of a food service system (e.g., the module 110, the canisters 126, etc.) in the form of food request output data, as discussed below.

In an exemplary embodiment, the temperature circuit 832 is configured to receive temperature input data. According to an exemplary embodiment, the temperature circuit 832 is configured to receive temperature input data from components of a food service system (e.g., the TFS system 100 of FIG. 1, the first enclosure 120 of the first housing 112, the second enclosure 140 of the second housing 116, a compressor, mechanical and/or electrical components, etc.). In some embodiments, the temperature circuit 832 receives temperature input data from a sensor (e.g., a sensor in the first enclosure 120, the second enclosure 140). In an exemplary embodiment, the temperature circuit 832 is also configured to process and/or communicate temperature data to components of the module 110 (e.g., a compressor, mechanical and/or electrical components of the second enclosure 140 or the first enclosure 120, etc.), in order to maintain the temperature of the module 110 (e.g., the first enclosure 120) at, or around, a target temperature. For example, the temperature circuit 832 may receive temperature input data from the first enclosure 120, process the temperature input data, and communicate temperature output data to the components of second enclosure 140 (e.g., a compressor, condenser, evaporator, expansion valve, fans, heat exchangers, refrigeration coils, etc.) in order for the components of the second enclosure 140 to maintain the temperature of the first enclosure 120 at/around a target temperature. In some embodiments, the temperature circuit 832 is further configured to process and/or communicate temperature data to other components of the food service system 800 (e.g., the merchant device 160, the dispenser device 824, etc.) and/or other components of a food service system (e.g., an external device, a warning indicator, etc.) in the form of temperature output data.

In an exemplary embodiment, the merchant device circuit 834 is also configured to receive food request input data. According to an exemplary embodiment, the merchant device circuit 834 is configured to receive food request input data from an external device (e.g., an order from the merchant device 160, etc.). Based on the food request input data, the merchant device circuit 834 may be configured to determine the properties of the food request (e.g., food type, food quantity, order of preparing food products, etc.). In some embodiments, the merchant device circuit 834 is further configured to communicate the food request input data to other components of the food service system 800 (e.g., the dispenser circuit 830, the dispenser device circuit 838, etc.) for further processing. In yet other embodiments, the merchant device circuit 834 is configured to communicate the food request properties to other components of the food service system 800 (e.g., the merchant device 160, the dispenser device 824, etc.) in the form of food request output data, as discussed below.

In an exemplary embodiment, the user device circuit 836 is also configured to receive food request input data. According to an exemplary embodiment, the user device circuit 836 is configured to receive food request input data from an external device (e.g., an order from the user device 822, etc.). Based on the food request input data, the user device circuit 836 may be configured to determine the properties of the food request (e.g., food type, food quantity, order of preparing food products, etc.). In some embodiments, the user device circuit 836 is also configured to communicate the food request input data to other components of the food service system 800 (e.g., the dispenser circuit 830, the dispenser device circuit 838, etc.) for further processing. In yet other embodiments, the user device circuit 836 is configured to communicate the food request properties to other components of the food service system 800 (e.g., the user device 822, the dispenser device 824, etc.) in the form of food request output data, as discussed below.

According to an exemplary embodiment, the dispenser device circuit 838 is configured to receive food request input data and/or food request output data. In an exemplary embodiment, the dispenser device circuit 838 receives food request input data (and/or food request output data) from other components of the food service system 800 (e.g., the dispenser circuit 830, the merchant device circuit 834, the user device circuit 836, etc.). Based on the food request input data (and/or the food request output data), the dispenser device circuit 838 may determine the properties of the food request (e.g., food type, food quantity, order of preparing food products, etc.). The dispenser device circuit 838 may be further configured to communicate the food request properties to other components of the food service system 800 (e.g., the dispenser device 824) in the form of food service output data, as discussed below.

In some embodiments, the dispenser device circuit 838 may also be configured to monitor the properties of various components of a food service system. For example, the dispenser device circuit 838 may receive component input data (e.g., usage data from the canister 126, weight data from the canister 126, etc.), and determine the level of food products in the food service system. In some embodiments, the dispenser device circuit 838 receives component input data (e.g., usage data, temperature data, etc. from components of the first enclosure 120, the second enclosure 140, etc.). Based on the component input data, the dispenser device circuit 838 may further be configured to communicate the component data to other components of the food service system 800 (e.g., the merchant device 160, the dispenser device 824, etc.) and/or other components of a food service system (e.g., an external device, etc.) in the form of component output data.

Referring still to FIG. 45, and as discussed briefly above, in an exemplary embodiment the controller 802 also includes the communications interface 812. According to an exemplary embodiment, the communications interface 812 is structured to provide and enable communications between and among the processing circuit 804, the control system 810, and external devices (e.g., the merchant device 160, the user device 822, the dispenser device 824, etc.).

As shown in FIG. 45, in an exemplary embodiment the food service system 800 also includes the merchant device 160. The merchant device 160 may be a computing device including a memory (e.g., RAM, ROM, Flash memory, hard disk storage, etc.), a processor (e.g., a general purpose processor, an application specific integrated circuit (ASIC), one or more field programmable gate arrays (FPGAs), a group of processing components, or other suitable electronic processing components), and a user interface (e.g., a touch screen). The merchant device 160 may include, for example mobile phones, electronic tablets, laptops, desktop computers, workstations, and other types of electronic devices, which allow a user to interact with the components of the food service system 800 (e.g., through the interface 700, an interface). In an exemplary embodiment, the merchant device 160 communicates (e.g., send, receive, transmit, etc. data) with the controller 802 via the communications interface 812. In some embodiments, the merchant device 160 is also connected to the user device 822 and/or the dispenser device 824 via an intranet or via the Internet, either via a wired connection or a wireless connection. According to an exemplary embodiment, the merchant device 160 is configured to receive input data (e.g., from a user via a touchscreen, from the user device 822, from the dispenser device 824, etc.), communicate the input data (e.g., in the form of merchant output data) to the controller 802 via the communications interface 812. As discussed briefly above, the circuits (e.g., circuits 830-838) may receive and process the merchant output data, and provide additional output data (e.g., food request output data) to other components of the food service system 800 (e.g., the dispenser device 824, the canisters 126, etc.). In this regard, the merchant device 160, the controller 802 (e.g., circuits 830-838), and other components of the food service system 800 (e.g., the dispenser device 824, etc.) may be in communication in order to process a food request and provide food.

As shown in FIG. 45, in an exemplary embodiment the food service system 800 also includes the user device 822. Similar to the merchant device 160 discussed above, the user device 822 may be a computing device including a memory, a processor, one or more field programmable gate arrays, a group of processing components (or other suitable electronic processing components), and a user interface (e.g., a touch screen). The user device 822 may include, for example mobile phones, electronic tablets, laptops, desktop computers, workstations, and other types of electronic devices, which allow a user to interact with the components of the food service system 800 (e.g., through an interface). In an exemplary embodiment, the user device 822 also includes a user application. The user application may be configured to communicate (e.g., receive, transmit, send, etc. data) with the user device 822, and other components of the food service system 800. For example, the user application may be configured to receive input data (e.g., food request input data from a user via a touchscreen, voice command, etc.), communicate the input data (in the form of user application output data) to the controller 802 via the communications interface 812. As discussed above, the circuits (e.g., circuits 830-838) may receive and process the user application output data, and provide additional output data (e.g., food request output data) to other components of the food service system 800 (e.g., the dispenser device) in order to process a food request and provide food.

As shown in FIG. 45, in an exemplary embodiment the food service system 800 also includes the dispenser device 824. The dispenser device 824 may be any suitable device for dispensing food products, for example, the module 110, the canisters 126, the dispenser 508, an electric motor thereof, etc. According to an exemplary embodiment, the dispenser device 824 is configured to communicate (e.g., receive, transmit, send, etc. data) with the controller 802 via the communications interface 812. In this regard, the dispenser device 824 may be configured to receive output data (e.g., control signals, food request output data from the dispenser circuit 830, the dispenser device circuit 838, etc.), and dispense food products based on the food request output data (e.g., a specific type of food, quantity of food, order of preparing food, etc.). In some embodiments, the dispenser device 824 is also configured to communicate data (e.g., component data from components of the module 110, the canisters 126, a sensor, etc.) to the controller 802 via the communications interface 812. As discussed briefly above, the circuits (e.g., circuits 830-838) may receive and process the data, and provide additional output data (e.g., component data) to other components of the food service system 800.

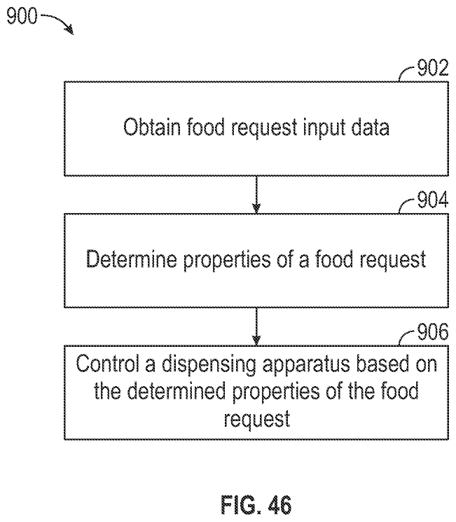

Referring now to FIG. 46, a process 900 for providing a food service is shown, according to an exemplary embodiment. According to an exemplary embodiment, the process 900 may be executed using the components of the TFS system 100 of FIG. 1 and/or the food service system 800 of FIG. 45.

At step 902, food request input data is obtained, according to an exemplary embodiment. In an exemplary embodiment, the food request input data includes data from a sensor (e.g., the sensor 122 of the first housing 112, the foot pedal 142 of the second housing 116, the elbow actuator 152 of the counter 118, the dispenser sensor 532 of the canister 126, etc.), for example indicating the position of tableware (e.g., a bowl below the canister 126). In other embodiments, the food request input data includes data from an external device (e.g., an order provided via the merchant device 160, the user device 822, a user application, etc.). In yet other embodiments, the food request input data includes data from other components of a food service system (e.g., an interface, a motion sensor, a voice command device, a visual sensor, etc.).

At step 904, the properties of a food request are determined, according to an exemplary embodiment. In an exemplary embodiment, the properties of the food request include the type of food, the quantity of food, the order of preparing the food, and/or any other suitable property relating to providing a food service. In some embodiments, the properties of the food request are predetermined (e.g., a predetermined recipe provided by a merchant, owner, supervisor, based on health requirements, safety regulations, etc.). In other embodiments, the properties of the food request are provided via a sensor (e.g., the sensor 122 of the first housing 112, the foot pedal 142 of the second housing 116, the elbow actuator 152 of the counter 118, the dispenser sensor 532 of the canister 126, etc.), for example based on how long a piece of tableware is in a certain position (e.g., a bowl is below the canister 126, etc.). In yet other embodiments, the properties of the food request are provided via a user (e.g., an order via the merchant device 160, a user device 822, etc.).

At step 906, a dispensing apparatus is controlled based on the determined properties of the food request, according to an exemplary embodiment. In an exemplary embodiment, the dispensing apparatus is controlled to provide a food product, or food products, (e.g., to a piece of tableware, to a user, etc.) based on the properties of the food request that were determined in step 904. The dispensing apparatus may be any suitable device for dispensing a food product. For example, the dispensing apparatus may be various components of the TFS system 100 of FIG. 1 (e.g., the module 110, the canister 126, the power supply module 226, the dispenser 508, the drive motor module 510, etc.) and/or the food service system 800 of FIG. 45 (e.g., the dispenser device 824, etc.).

As an illustrative example, a user may wish to order food (e.g., a salad, soup, a fruit cup, etc.) via a user application on a user device (e.g., the user device 822). The user may use the user device 822 (and/or the user application) to place an order, which may be communicated to the controller 802 via the communications interface 812 (e.g., in the form of food request input data, etc.). The circuits (e.g., the user device circuit 836, the dispenser circuit 830, and/or the dispenser device circuit 838, etc.) may process the food request input data, and determine the properties of the food request. In this regard, the type of food, quantity of food, the order of preparing food, etc. may be determined in order to properly prepare a food request. The circuits (e.g., the user device circuit 836, the dispenser circuit 830, and/or the dispenser device circuit 838, etc.) may further provide output data (e.g., in the form of food request output data, etc.) to dispensing components (e.g., the module 110, the canister 126, the drive motor module 510, the dispenser device 824, etc.) in order to dispense food. In some embodiments, the food request output data may be utilized by components of the TFS system 100 of FIG. 1 (and/or the food service system 800 of FIG. 45) to guide (e.g., via indicators, lights, verbal instructions, visual instructions, etc.) a user through food request preparation. In this regard, the user may assist in preparing the food request (e.g., move a plate between the canisters 126, etc.).

As another illustrative example, a user may wish to order food (e.g., a salad, soup, a fruit cup, etc.) via a merchant device (e.g., the merchant device 160). The user may place an order using the merchant device 160, for example by voice command, by scanning an application on a user device, via a touchscreen interface, etc. The order may be communicated to the controller 802 via the communications interface 812 (e.g., in the form of food request input data, etc.). The circuits (e.g., the merchant device circuit 834, the dispenser circuit 830, and/or the dispenser device circuit 838, etc.) may process the food request input data, and determine the properties of the food request. The circuits (e.g., the merchant device circuit 834 the dispenser circuit 830, and/or the dispenser device circuit 838, etc.) may further provide output data (e.g., in the form of food request output data, etc.) to dispensing components to dispense food (e.g., the module 110, the canister 126, the drive motor module 510, the dispenser device 824, etc.). The food request output data may also be utilized to guide (e.g., via indicators, lights, verbal and/or visual instructions, etc.) a user through food request preparation.

As yet another illustrative example, a user may wish to order food (e.g., a salad, soup, a fruit cut, etc.) using components of the TFS system 100 of FIG. 1 and/or the food service system 800 of FIG. 45. The user may select the type of food product the user desires by looking at the food products available (e.g., through a transparent dividing surface 130, via signage, etc.). Once the user selects the type of food the user desires, the user may place a piece of tableware (e.g., a bowl, a plate, a basket, etc.) under a dispensing component (e.g., on the positioning indicator 150 of the counter 118, below the canister 126, below the first housing 112, etc.). A food request may be communicated to the controller 802 via the communications interface 812 (e.g., in the form of food request input data, etc.). As discussed briefly above, the food request input data may include tableware position data provided via a sensor (e.g., the sensor 122 of the first housing 112, the dispenser sensor 532 of the canister 126, etc.), which indicates a piece of tableware is located proximate to a dispensing component. In some embodiments, the food request input data includes food quantity data that is provided via a different sensor (e.g., the foot pedal 142 of the second housing 116, the elbow actuator 152 of the counter 118, etc.), which allows a user to indicate when a piece of tableware is proximate to a dispensing component and/or control the amount of food dispensed from the dispensing component. In yet other embodiments, the food request input data is provided via an interface (e.g., electronics on the dividing surface 130, etc.), which allows a user to control the amount of food dispensed from the dispensing component. The circuits (e.g., the dispenser circuit 830, and/or the dispenser device circuit 838, etc.) may process the food request input data, and determine the properties of the food request. The circuits (e.g., the dispenser circuit 830, and/or the dispenser device circuit 838, etc.) may further provide output data (e.g., in the form of food request output data, etc.) to dispensing components to dispense the food (e.g., the module 110, the canister 126, the drive motor module 510, the dispenser device 824, etc.). In an exemplary embodiment, the circuits may process input data and/or provided output data in real-time.

The apparatus and methods described herein are therefore enabled to provide a touchless (e.g., minimal contact, reduced contact, minimal user-food interaction, reduced user-food interaction, etc.) self-service food service that provides users with various food products (salad, dry goods, cereal, soup, yogurt, fruit, vegetables, frozen foods, noodles, grains, meals, entrees, drinks, warm food products, hot food products, ambient food products, frozen food products, chilled food products, condiments, etc.). In this regard, the apparatus and methods described herein reduce the interactions between the food products and the user, and provide a more sanitary (e.g., less user-food interaction, less or no cross-contamination of different foods, etc.) self-service system. Further, the apparatuses and methods provide for a broader range of food products, a customizable selection for the user, and a capacity to service multiple users.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure.

Likewise, software implementations could be accomplished with standard programming techniques with rule-based logic and other logic to accomplish the various connection steps, processing steps, comparison steps, and decision steps.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While various circuits with particular functionality are shown in FIG. 45, it should be understood that the controller 802 may include any number of circuits for completing the functions described herein. For example, the activities and functionalities of the circuits 830-838 may be combined in multiple circuits or as a single circuit. Additional circuits with additional functionality may also be included. Further, the controller 802 may further control other activity beyond the scope of the present disclosure

As mentioned above and in one configuration, the “circuits” may be implemented in machine-readable medium for execution by various types of processors, such as the processor 806 of FIG. 45. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network

While the term “processor” is briefly defined above, the term “processor” and “processing circuit” are meant to be broadly interpreted. The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that any element disclosed in one embodiment may be incorporated or utilized with any other embodiment disclosed herein. For example, the food service system 800 of the exemplary embodiment described in at least FIG. 45 may be incorporated in the TFS system 100 of the exemplary embodiment described in at least FIGS. 1-5. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A food service system for controllably dispensing a first food product, the food service system comprising:
a housing having a first bay defined by one or more walls;
a first positioning bracket mounted in the first bay and having a first opening;
a first power supply module having a first mounting interface;
a first canister configured to selectively couple with the first power supply module and controllably dispense the first food product using power from the first power supply module, wherein the first canister comprises a first receptacle, a first base coupled to the first receptacle, and a first dispenser, the first base having a first outlet aligned with the first opening in the first positioning bracket; and
a first drive motor module removably mounted to the first base and operatively coupled to the first dispenser;
wherein the first canister is removably mounted in the first bay by at least an engagement between the first drive motor module and the first mounting interface of the first power supply module; and
wherein the first drive motor module actuates the first dispenser in response to an electrical signal and the first dispenser controllably dispenses the first food product from the first receptacle to the first outlet.

2. The food service system of claim 1, further comprising a temperature control system and a temperature controlled compartment, wherein the temperature control system is configured to provide a temperature controlled airflow to the temperature controlled compartment.

3. The food service system of claim 2, wherein the temperature control system is a cooling system and the temperature controlled airflow is a chilled airflow, and wherein the housing comprises a first fan configured to direct at least a portion of the chilled airflow in a first direction along the first canister to cool the first canister.

4. The food service system of claim 1, further comprising a cooling system providing a chilled airflow, wherein the first positioning bracket comprises an aperture configured to direct at least a portion of the chilled airflow to isolate the first canister from ambient air outside the housing.

5. The food service system of claim 4, wherein the aperture is a slot having an elongated dimension approximate the first opening in the first positioning bracket.

6. The food service system of claim 4, wherein the first outlet of the first canister is disposed above the aperture in the first positioning bracket.

7. The food service system of claim 1, further comprising:
a second positioning bracket mounted in the first bay and having a second opening;
a second canister configured to selectively couple with the first power supply module and controllably dispense a second food product, wherein the second canister comprises a second receptacle, a second base, and a second dispenser; and
a second drive motor module removably mounted to the second base and operably coupled to the second dispenser;
wherein the first power supply module includes a second mounting interface;
wherein the second base includes a second outlet aligned with the second opening;
wherein the second canister is removably mounted in the first bay by at least an engagement between the second drive motor module and the second mounting interface of the first power supply module; and
wherein the second drive motor module actuates the second dispenser in response to a second electrical signal and the second dispenser controllably dispenses the second food product from the second receptacle to the second outlet.

8. The food service system of claim 7, wherein the housing further comprises a second bay defined by one or more walls, and further comprising:
a third positioning bracket mounted in the second bay and having a third opening;
a second power supply module having a plurality of mounting interfaces;
a third canister configured to selectively couple with the second power supply module and controllably dispense a third food product, wherein the third canister comprises a third receptacle, a third base, and a third dispenser; and
a third drive motor module removably mounted to the third base and operably coupled to the third dispenser;
wherein the third base includes a third outlet aligned with the third opening;
wherein the third canister is removably mounted in the second bay by at least an engagement between the third drive motor module and one of the plurality of mounting interfaces of the second power supply module; and
wherein the third drive motor module actuates the third dispenser in response to a third electrical signal and the third dispenser controllably dispenses the third food product from the third receptacle to the third outlet.

9. A food dispensing apparatus comprising:
a receptacle configured to selectively house a food product;
a base coupled to the receptacle, the base comprising an outlet configured to align with an opening;
a dispenser configured to controllably dispense the food product; and
a drive motor module operably coupled to the dispenser, wherein the drive motor module is configured to use power from a power supply module to cause the dispenser to controllably dispense the food product from the food dispensing apparatus.

10. The food dispensing apparatus of claim 9, wherein the dispenser further comprises a spindle coupled to a plurality of paddles, wherein the spindle is coupled to the base and the drive motor module, and wherein the drive motor module is configured to selectively rotate the spindle and the plurality of paddles in a first direction to controllably dispense the food product.

11. The food dispensing apparatus of claim 10, wherein the drive motor module is configured to selectively rotate the spindle and the plurality of paddles in a second direction, wherein the first direction and the second direction are opposite.

12. The food dispensing apparatus of claim 9, further comprising an agitation object positioned within the receptacle proximate to the dispenser, wherein the agitation object is configured to selectively engage the dispenser and the food product to agitate the food product within the receptacle.

13. The food dispensing apparatus of claim 12, wherein the agitation object comprises at least one of a spherical body, a wedge, or an elongated member.

14. The food dispensing apparatus of claim 13, wherein the agitation object comprises a plurality of protrusions extending from one or more surfaces of the agitation object.

15. The food dispensing apparatus of claim 9, wherein the dispenser further comprises a sensor positioned below the outlet, wherein the sensor is configured to cause the drive motor module to control the dispenser to controllably dispense the food product.

16. The food dispensing apparatus of claim 9, wherein at least one of the base and the drive motor module comprises a hook, and the other of the base and the drive motor module comprises a protrusion, wherein the protrusion engages the hook to secure the base to the drive motor module.

17. The food dispensing apparatus of claim 16, wherein the drive motor module comprises a catch that engages the base to further secure the base to the drive motor module.

18. The food dispensing apparatus of claim 9, wherein the drive motor module comprises a driver with a plurality of pins extending therefrom, and the dispenser comprises a spindle with a cross-member that is inserted between the plurality of pins such that when the driver is rotated, the plurality of pins impart rotation on the spindle through engagement with the cross-member.

19. A method of providing a food service, the method comprising:
obtaining food request input data including a first set of sensor data from a first sensor positioned below a first opening of a first canister;
determining properties of a food request based on the food request input data; and
controlling the first canister based on the determined properties of the food request to provide a first food product of the food request;
wherein the first set of sensor data is a first set of proximity sensor data indicating that a dishware is positioned below the first opening;
wherein controlling the first canister includes using power from a first power supply module to cause a first drive motor module to actuate a first dispenser; and
wherein actuating the first dispenser includes selectively rotating a first spindle coupled to a first plurality of paddles in a first direction to controllably dispense the first food product from the first canister.

20. The method of claim 19, further comprising:
controlling a second canister based on the determined properties of the food request to provide a second food product of the food request;
wherein the food request input data includes a second set of sensor data from a second sensor positioned below a second opening of the second canister;
wherein the second set of sensor data is a second set of proximity sensor data indicating that the dishware is positioned below the second opening;
wherein controlling the second canister includes using power from a second power supply module to cause a second drive motor module to actuate a second dispenser; and
wherein actuating the second dispenser includes selectively rotating a second spindle coupled to a second plurality of paddles in a second direction to controllably dispense the second food product from the first canister.
